(19) United States
(12) Patent Application Publication
(10) Pub. No.: US 2010/0218037 A1
(43) Pub. Date: Aug. 26, 2010

(54) Matrix-based Error Correction and Erasure Code Methods and Apparatus and Applications Thereof

(75) Inventors: Robert Swartz, Highland Park, IL (US); David Riceman, Highland Park, NJ (US); Roger Critchlow, Sante Fe, NM (US); Ronald Lachman, Northbrook, IL (US)

Correspondence Address: NORMA E HENDERSON;HENDERSON PATENT LAW, 13 JEFFERSON DR, LONDONDERRY, NH, 03053, US

(73) Assignee: File System Labs LLC, Northbrook, IL (US)

(21) Appl. No.: 12/561,252

(22) Filed: Sep. 16, 2009

Related U.S. Application Data
(60) Provisional application No. 61/097,345, filed on Sep. 16, 2008.
(60) Provisional application No. 61/175,779, filed on May 5, 2009.

(51) Int. Cl. G06F 11/20

(52) U.S. Cl. 714/6; 714/E11.084

(57) ABSTRACT

A distributed data storage system breaks data into n slices and k checksums using at least one matrix-based erasure code based on matrices with invertible submatrices, stores the slices and checksums on a plurality of storage elements, retrieves the slices from the storage elements, and, when slices have been lost or corrupted, retrieves the checksums from the storage elements and restores the data using the at least one matrix-based erasure code and the checksums. In a method for ensuring restoration and integrity of data in computer-related applications, data is broken into n pieces, k checksums are calculated using at least one matrix-based erasure code based on matrices with invertible submatrices, and the n data pieces and k checksums are stored on n+k storage elements or transmitted over a network. If, upon retrieving the n pieces from the storage elements or network, pieces have been lost or corrupted, the checksums are retrieved and the data is restored using the matrix-based erasure code and the checksums.

### RELATED APPLICATIONS

This application claims the benefit of U.S. Provisional Application Ser. No. 61/097,345, filed Sep. 16, 2008, the entire disclosure of which is herein incorporated by reference. This application also claims the benefit of U.S. Provisional Application Ser. No. 61/175,779, filed May 5, 2009, the entire disclosure of which is herein incorporated by reference.

### FIELD OF THE TECHNOLOGY

The present invention relates to error correction codes and, in particular, to erasure codes for data storage and other computing-related applications.

### BACKGROUND

Error correcting techniques have been used for many years to add reliability to information processing and communications systems. While many such applications are hardware-based, software-based forward error correction techniques have recently been used to add reliability to packet-based communications protocols. In general, forward error correction techniques prevent losses by transmitting or storing some amount of redundant information that permits reconstruction of missing data. These techniques are generally based on the use of error detection and correction codes.

Error correcting and similar codes can be divided into a number of classes. In general, error correcting codes are data representations that allow for error detection and error correction if the error is of a specific kind. The types of errors range from simple checksums and error detecting codes to more complicated codes, of which erasure codes, such as Reed-Solomon codes, are an example. Erasure codes, as the term is used herein, transform source data of k blocks into data with n blocks (n being more than k), such that the original data can be reconstructed using any k-element subset of the n blocks. In particular, erasure codes may be used in forward error correction to allow reconstruction of data that has been lost when the exact position of the missing data is known. They may also be used to help resolve latency issues if multiple computers hold different parts of the encoded data.

There are number of examples of such codes. Members of one class, called Tornado codes, were developed by Luby and others [e.g. Luby et al., “Practical Loss-Resilient Codes”; Luby et. al., “Efficient Erasure Correcting Codes”, IEEE Transactions on Information Theory 47:2, (2001) 569-584] and have encoding and decoding times that scale linearly with the size of the message. Tornado codes are probabilistic, in that they will fix errors with a given probability, but there is always the small but real likelihood of failure.

Work has also been performed by Luby and others on erasure codes that are deterministic [Blomer et. al., “An XOR-Based Erasure Resilient Coding Scheme”, Technical Report of the ICSI TR-95-048 (1995); Luby et. al., “Efficient Erasure Correcting Codes”, IEEE Transactions on Information Theory 47:2, (2001) 569-584; Rizzo, Luigi, “Effective Erasure Codes for Reliable Computer Communication Protocols”, ACM Computer Communication Review, Vol. 27, No. 2, April 1997, pp. 24-36], such as Cauchy-based and Vandermonde-based Reed-Solomon codes. However, Luby states that these codes are much slower to decode than Tornado codes [Luby, Michael, “Benchmark comparisons of erasure codes”, University of Berkeley, web publication], with the encoding and decoding times of Reed-Solomon codes scaling quadratically or worse with the size of the message and software-based implementations of Tornado codes consequently being about 100 times faster on small length messages and 10,000 times faster on larger lengths. Although the data Luby produces is accurate, he assumes that he is working with systems with high number of errors.

There has long been a tension between what has historically been called timesharing and dedicated computing. Over the years the pendulum has swung between these two poles. At first, computers were single entities unconnected to other computers. These machines originally ran programs sequentially, but later timesharing was invented, which time sliced the computer among many programs and users so that one computer could be used simultaneously by many users. Before the advent of the microprocessor, timesharing systems such as Unix were on the upswing, since it was very efficient to share large computer resources. With the advent of inexpensive microprocessor-based machines, the pendulum swung back to each user having his or her own machine, although the machine was then time-sliced among many programs.

The mantra today is “cloud computing”, where a large group of machines is either networked together over a WAN or LAN, or both sit in a cloud and users use the web and their computer and web browser as a terminal in order to obtain computing services. This ‘cloud’ of computers is similar to the mainframe used for timesharing, and benefits from the advantages of the timesharing model. In addition, many companies are providing programs such as spreadsheets, word processors, graphics programs, and other services over the web, where the computational resource is in a ‘cloud’ or large server farm. One of the recurrent problems with these designs, however, is that adding capacity is difficult and complicated and a number of kludges have to be used to scale such systems.

One of the major challenges that has faced users of computers is how to parallelize computation. This has been a problem for decades, and it has become even more acute with the advent of multicore processors and server farms. It is viewed as a critical challenge by many microprocessor manufacturers. The other half of this problem is the distribution of computation. Languages such as Erlang allow for the distribution of computation in a fault tolerant way. An example of distributed computation without using the advantages of erasure code methods is Scalaris [Schutt, Thorsten, et al., “Scalaris: Distributed Transactional Key-Value Store”, Zuse Institute Berlin CSR; OnScale Solutions, Berlin, Germany]. Distribution of computing allows for faster computation, although the optimal distribution is in general NP-complete (Nondeterministic Polynomial time complete).

The distribution of data may be speeded up by having multiple producers of that data. This is true even when the producers hold different parts of the data due to different I/O speeds as well as the inherent asymmetry between a fast download speed and a slow upload speed on many internet connections. Two examples of this are BitTorrent and the Zebra file system [Hartman, John H. et al., “The Zebra Striped Network File System”, ACM Transactions on Computer Systems, Vol. 13, Issue 3, August 1995, pp. 274-310]. In the case of the Zebra file system, data is sliced up (i.e. simply divided) onto multiple disk drives and when it is desired to retrieve it, it is reassembled from multiple sources. Retrieval is speeded up by this method, since the use of multiple producers provides better use of both channel and network bandwidth, as well as better utilization of disks and their controllers. However, this system is not fault tolerant and it is not easy to add resources to it. BitTorrent has many of the advantages of the Zebra file system, in that has many producers of data and is also fault tolerant, but its fault tolerance is obtained at the cost of immense redundancy since the data must be replicated many times. This means that the system must store complete copies of every piece of data that it wishes to store.

Data integrity is typically ensured by means of a backup method in which the data is reproduced and kept in another location. There are at least two copies of the data, and if one copy is destroyed then hopefully the other is still intact. From a practical point of view, this process has problems, since anyone who does regular backups knows that when it is necessary to retrieve the data from the backup, it is not infrequent that something has gone wrong and the backup is no good. Even if the backup is good, if all backups are destroyed then the data is still lost. Typically, a third (or more) backups are therefore made to defend against this possibility. Of course, it could happen that all three or more backups could be destroyed. The fact is that no backup scheme can guarantee that data will not be lost. Further, this method is also very inefficient, since it requires a doubling or tripling of the amount of storage needed. Typical commercial installations, such as RAID (Redundant Array of Inexpensive Disks) and the Google file system, utilize this method.

### SUMMARY

A method and apparatus for distributing data among multiple networks, machines, drives, disk sectors, files, message packets, and/or other data constructs employs matrix-based error correcting codes to reassemble and/or restore the original data after distribution and retrieval. In one aspect, the invention provides a fault-tolerant distributed data storage and retrieval system that delivers data at high speed and low cost. In another aspect, the invention is a method and apparatus for error correction in data storage and other computer-related applications. The method of error correction of the present invention is deterministic. In yet another aspect, the invention is, and employs, a new class of erasure codes that have a number of advantages over previous methods and a large number of applications. The erasure codes may be used in any application where older and/or less efficient erasure codes are presently used. In a further aspect, the present invention is a method and system for efficient distributed computing.

In one aspect of the invention, a distributed data storage system breaks data into n slices and k checksums using at least one matrix-based erasure code based on a type of matrix selected from the class of matrices whose submatrices are invertible, stores the slices and checksums on a plurality of storage elements, retrieves the n slices from the storage elements, and, when slices have been lost or corrupted, retrieves the checksums from the storage elements and restores the data using the at least one matrix-based erasure code and the checksums. In a preferred embodiment, some of the storage elements are disk drives or flash memories. The storage elements may comprise a distributed hash table. In preferred embodiments, the matrix-based code uses Cauchy or Vandermonde matrices. The system may be geographically distributed.

In another aspect of the invention, a distributed file system comprises a file system processor adapted for breaking a file into n file pieces and calculating k checksums using at least one matrix-based erasure code based on a type of matrix with an invertible submatrix, for storing or transmitting the slices and checksums across a plurality of network devices, for retrieving the n file pieces from the network devices and, when file pieces have been lost or corrupted, for retrieving the checksums from the network devices and restoring the file using the at least one matrix-based erasure code and the checksums.

In yet another aspect of the invention, a method for ensuring restoration and integrity of data in computer-related applications, comprises the steps of breaking the data into n pieces; calculating k checksums related to the n pieces using at least one matrix-based erasure code, wherein the matrix-based erasure code is based on a type of matrix selected from the class of matrices whose submatrices are invertible; storing the n pieces and k checksums on n+k storage elements or transmitting the n pieces and k checksums over a network; retrieving the n pieces from the storage elements or network; and if pieces have been lost or corrupted, retrieving the checksums from the storage elements or network and restoring the data using the matrix-based erasure code and the checksums.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a flow diagram of an implementation of a preferred embodiment of a method for ensuring restoration or receipt of data, according to one aspect of the present invention;

FIG. 2 is a flow diagram of an embodiment of the process of creating checksums, according to one aspect of the present invention;

FIG. 3 is a flow diagram of an embodiment of the process of decoding checksums, according to one aspect of the present invention;

FIG. 4 is a conceptual diagram of an embodiment of the process of finding the Cauchy submatrix, according to one aspect of the present invention;

FIG. 5 is a block diagram illustrating an embodiment of the process of dispersing data slices in a network, according to one aspect of the present invention;

FIG. 6 is a block diagram illustrating an embodiment of the process of dispersing data slices on disk tracks, according to another aspect of the present invention;

FIG. 7 is a block diagram illustrating an embodiment of the process of dispersing data slices on a multiple platter disk drive, according to one aspect of the present invention;

FIG. 8 is a block diagram illustrating an embodiment of a distributed file system employing web servers, according to one aspect of the present invention;

FIG. 9 is a block diagram illustrating an embodiment of a system for distributed database computation, according to another aspect of the present invention; and

FIG. 10 is a diagram that illustrates an exemplary implementation of distributed data storage according to one aspect of the present invention.

### DETAILED DESCRIPTION

In the present invention, a method and apparatus for distributing data among multiple networks, machines, drives, disk sectors, files, message packets, and/or other data constructs employs matrix-based error correcting codes to reassemble and/or restore the original data after distribution and retrieval. A fault-tolerant distributed data storage and retrieval system according to the invention delivers data at high speed and low cost. In another aspect, the invention is a method and apparatus for error correction in data storage and other computer-related applications. The method of error correction of the present invention is deterministic. In yet another aspect, the present invention is, and employs, a new class of erasure codes that have a number of advantages over previous methods and a large number of applications. The erasure codes of the present invention may be used in any application where older and/or less efficient erasure codes are presently used. In a further aspect, the present invention is a method and system for efficient distributed computing.

In one embodiment, data is distributed among multiple machines in a more efficient way by employing matrix-based codes. The class of suitable matrices includes all those whose square submatrices are invertible, such as, but not limited to, Cauchy matrices and Vandermonde matrices. This distribution of data radically reduces the amount of redundancy necessary to make sure no data is lost, as well as permitting more efficient processing in a multiprocessor system. From a storage point of view, a disk drive connected to each processor is then no longer necessary. Even if a disk drive is desired, the size can be smaller. In another embodiment, data is distributed within a disk drive using matrix-based codes in order to make the data fault tolerant. In yet another embodiment, matrix-based codes are employed to achieve fault-tolerant communications. In a further embodiment, matrix-based codes are employed to implement flash memories.

In a preferred application, the present invention is a method and apparatus for ensuring restoration or receipt of data under possible failure, when it is known which transmissions or storage facilities have failed. In an embodiment of this preferred application of the present invention, suppose it is known that, of n+k disks, only k will fail in a unit of time. The application is then implemented by the following basic steps: (1) Break each file to be stored into n pieces; (2) Calculate k checksums; (3) Store these n+k pieces and checksums on the n+k disks (or other elements of storage whose failure is as likely to be independent as possible); and (4) If it is known which disks are functional, Cauchy-based Reed-Solomon codes [Blomer et. al., “An XOR-Based Erasure Resilient Coding Scheme”, Technical Report of the ICSI TR-95-048 (1995), improving on Rabin, “Efficient Dispersal of Information for Security, Load Balancing, and Fault Tolerance”, JACM 36:2, (1989) 335-348] or other suitable matrix-based codes are used to ensure that the file can be safely restored. If it is not known which storage elements are functional, this can be discovered by the decoding mechanism and then step (4) can be used. Similarly, this basic methodology applies and works equally well with a message, by the steps of: (1) Break the message into n pieces; (2) Calculate k checksums; (3) Transmit all n+k pieces and checksums; and (4) If it is known which n transmissions have been received, restore the original message using Cauchy-based Reed-Solomon codes or other suitable matrix-based codes. If it is not known which transmissions have been received, this can be discovered by the decoding mechanism and then step (4) can be used. It will be clear that, if there are no errors, then there is no additional overhead associated with decoding because no decoding is required since all the data is not encoded.

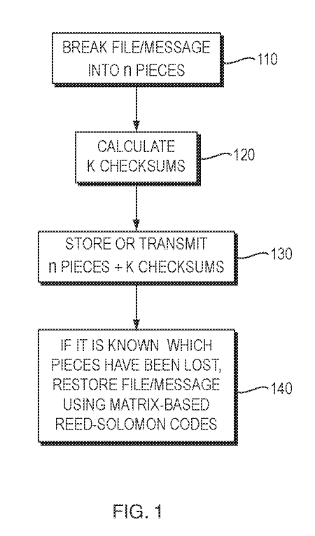

The operation of this embodiment is illustrated by the block diagram shown in FIG. 1. In FIG. 1, the file or message is broken into n pieces 110, and k checksums are calculated 120. All n pieces and k checksums are then transmitted 130. Assuming it is known, or it can be determined, which n transmissions have been received, the original message is restored 140 using the matrix-based codes of the present invention.

In particular, this application represents and provides a major improvement in the process of backing up files in a network. Rather than duplicating the entirety of the file system, the files need only be split among all of the stable disk drives in the network. A specially designed system is needed to retrieve the files as the user needs them, but rather than needing to duplicate all files, only

$$\frac{n + k}{n}$$

of the space the files occupy will be needed.

In some implementations, the slices may be subdivided into shreds. The length of the shred can be varied to optimize performance in different networks. For example, a long shred may be appropriate for a low-error channel (e.g., a LAN) and a shorter shred for a high-error channel. The system of the present invention provides the advantages of striping, blocking, and erasure coding in a single package. Striping distributes parts of data over independent communication channels so that the parts can be written and retrieved in parallel. Both the slicing and the shredding contribute to striping in the system. Blocking data breaks data into independent pieces that need not be dealt with as a unit or in a particular order. The shredding is the blocking operation. Erasure coding adds redundancy so that data may be reconstructed from imperfect storage nodes.

In the present invention, there is flexibility in the way that the slices may be retrieved to reconstruct data. For example, all the slices, data or checksums may be requested at once, and then the data can be reconstructed as soon as the necessary replies arrive. Alternatively, only the data slices can be initially requested, waiting to see if they are all available. Checksums are then requested only if data slices are missing. If all the data slices are retrieved initially, then they can simply be reassembled without the need to decode any checksums, thereby eliminating the computational overhead of decoding. In addition, an ordering of the nodes that respond with the lowest latency can be maintained, and slices requested from most responsive nodes first. A maximum number of outstanding slice requests permitted for a particular data item may also be specified, in order to ration use of network resources.

In the method of the present invention, each piece of data can be represented as a real number, as an element in a finite field, or as a vector over a finite field. In the preferred embodiment, finite fields are used since this obviates problems of roundoff error; however, it will be clear to one of skill in the art that the invention extends without change to real numbers or to any other representation of data on a computer.

One model of errors is that there is probability 1−p that any datum is transmitted correctly and probability p that it is known to be in error, independent of any other error. In real cases there are likely to be dependencies among the data (for example, a power failure may cause all of the disks in a building to fail). Real networks will have to distribute data and checksums diffusely to avoid these problems.

In describing a preferred embodiment of the present invention, Cauchy-based Reed-Solomon codes are described first, and then they are applied to the problem of network backup. A key feature of a Cauchy matrix is that each of its square sub-matrices is nonsingular (i.e., has a non-zero determinant) and thus is invertible. While Cauchy-based Reed-Solomon codes are employed in this description, it will be clear to one of skill in the art that many other suitable matrix-based codes exist, within the context of a general class of matrices all of whose square submatrices are invertible. For example, the system may be implemented with Vandermonde-Reed-Solomon codes or any other code that transforms source data of n blocks into data with r blocks (r being greater than n), such that the original data can be recovered from a subset of the r blocks. Further, the matrix-based codes of the present invention may be used in conjunction with one or more other error correction codes or erasure codes. For example, matrix-based codes according to the invention may act as an inner layer of code, and one or more error correction codes may act as an outer layer of code.

The algorithm is fast when the probability of transmission error is small, and it is easy to implement. In particular, with n data points (disks) and a probability p that a given piece of data will be transmitted in error, the algorithm is O(n²p). If the data are represented as a vector of length m, so that there are mn pieces of data, then the algorithm's speed is linear in m, that is, O(mn²p).

Mathematical definitions. Let n and k represent positive integers. Let x=(x₁, . . . , xₙ)εF_{q}ⁿ represent the original set of data. A checksum scheme is a function G:Fn F_{q}ⁿ→F_{q}^{n+k} with two special properties enabling recovery of the original data from any n points of G(x).

Symmetry: For j>0, let Σⱼ denote the set of permutations of j things. If y=G(x), it is required that, whenever σεΣₙ there exists a τεΣₙ₊ₖ such that τ(y)=G(σ(x)) and, whenever τεΣₙ₊ₖ there exists a σεΣₙ such that τ(y)=G(σ(x)). That is, the code should not depend on the order of the n points.

Completeness: Let πₙ:F_{q}^{n+k}ΘF_{q}ⁿ be the projection map such that:

πₙ(y₁, . . . , yₙ₊ₖ)=(y₁, . . . , yₙ)

It is required that, for any τεΣₙ₊ₖ, the map πₙoτoG be invertible. That is, it is desirable to be able to recover the original n data points from any n of the n+k data points they are mapped into.

Matrix notation is required. Let Iₙ={1, . . . , n}, the set containing the first n integers. If A={α_{i,j}:i,jεIₙ} is a square matrix, and Ø⊂J₁⊂Iₙ and Ø⊂J₂⊂Iₙ, A_{J}_{₁} is written for the square matrix A_{J}_{₁}={α_{i,j}:i,jεJ₁} and A_{J}_{₁}_{:J}_{₂} for the matrix A_{J}_{₁}_{:J}_{₂}={α_{i,j}:iεJ₁,jεJ₂}.

Checksums. Decompose the checksum scheme F into Fᵢ, 1≦i≦n+k. In this discussion, attention is restricted to the special case Fᵢ(x)=xᵢ, 1≦i≦n. The first n points are the data, and the other k points are checksums for restoring the data. There are many options for the remaining functions Fᵢ>n. Many non-linear functions are possible. The simplest function is the linear function Fᵢ=Σα_{i,j}xⱼ, i>n.

Let xᵢ, 1≦i≦n, denote the data, which lives in the finite field F₂_{¹⁶}. The checksums take the form Fᵢ=Σα_{i,j}xⱼ. Let eᵢ denote the unit vector in F_{q}ⁿ with i^{th} coordinate 1 and all other coordinates 0. Let the matrix A=α_{i,j} and all its submatrices have non-zero determinates. The Cauchy matrix, for example, satisfies this condition [Davis, “Interpolation and Approximation”, Dover, N.Y., 1975, pp. 268-269). In that case all of the data may be recovered from all of the checksums, or from any subset of checksums and data that contains at least n elements [Blomer et. al., “An XOR-Based Erasure Resilient Coding Scheme”, Technical Report of the ICSI TR-95-048 (1995)].

In operation, the present invention works as follows. Numbers fᵢ=Σα_{i,j}xⱼ are observed. If only n checksums are known, it is necessary only to solve the matrix equation Ax=f, or x=A⁻¹f. Now suppose n−q data points and q checksums are known. Let D⊂Iₙ denote the unknown data points, and let C⊂Iₙ denote the known checksums, so that |C|=|D|=q. Let gᵢ=Σα_{i,j}xⱼ, iεC, jεD. It is known that gᵢ=Σα_{i,j}xⱼ, iεC, jεD. By assumption the square submatrix A_{C:D} is invertible, and the solution is x=A_{C:D}⁻¹g. Note that if more than n points (data and checksum) are known, then the matrix is overdetermined. This can help with the discovery of errors.

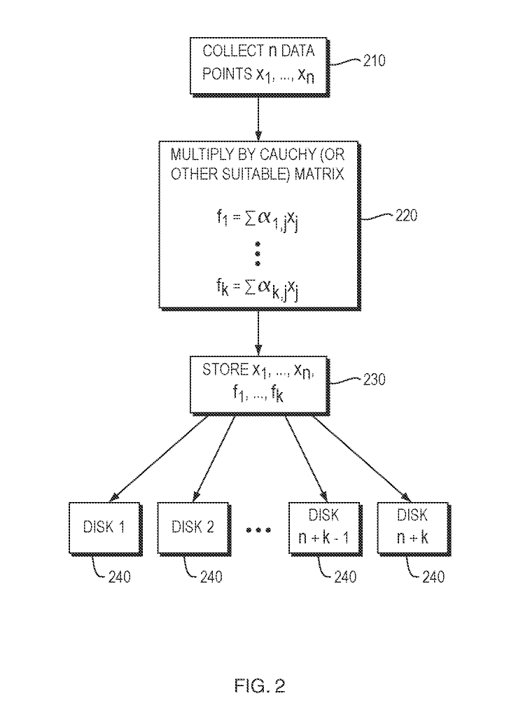

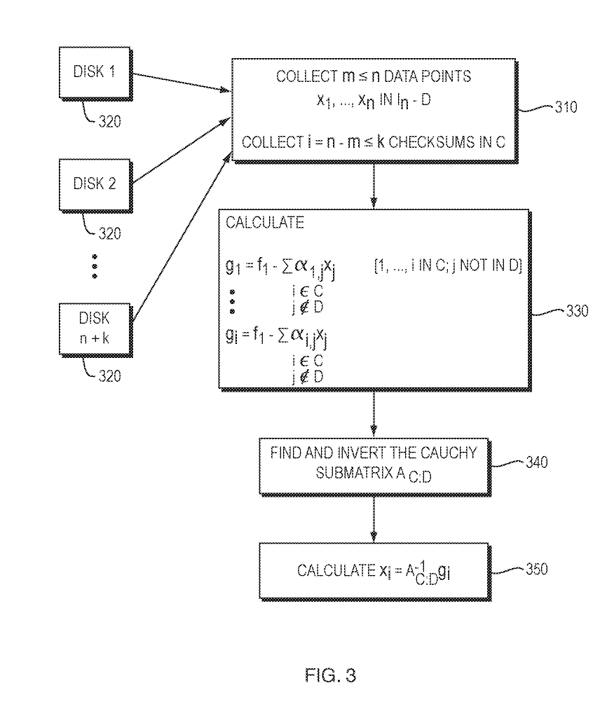

Preferred embodiments of the processes of creating and decoding checksums, respectively, are illustrated in the flow diagrams of FIGS. 2 and 3. In FIG. 2, the n data points are collected 210 and then multiplied by the Cauchy (or other suitable) matrix 220. The resulting data slices are then stored 230 on n+k disks 240. In FIG. 3, the data slices are collected 310 from the n+k disks 320. The reverse checksums are calculated 330, the Cauchy submatrix is found and inverted 340, and the original data points are reconstructed 350.

The Cauchy Matrix and Other Matrices. Let xᵢ and yⱼ, 1≦i≦n, 1≦j≦k be two sequences of numbers such that the xᵢ distinct, the yⱼ distinct, and xᵢ+yⱼ≠0 for every i and j. The matrix

$$A = {α}_{i , j} = \frac{1}{{x}_{i} + {y}_{j}}$$

is called a Cauchy matrix. Every square submatrix is invertible, and because of the special structure there are fast algorithms available for inversion.

When n=k the inverse matrix C satisfies:

$${c}_{i , j} = - {1}^{n - 1} ( {x}_{j} + {y}_{i} ) {\prod }_{k = 1 , k \neq j}^{n} \frac{{x}_{k} + {y}_{i}}{{x}_{j} - {x}_{k}} {\prod }_{k = 1 , k \neq i}^{n} \frac{{x}_{j} + {y}_{k}}{{y}_{k} - {y}_{i}}$$

[Davis, “Interpolation and Approximation”, Dover, N.Y., 1975, p. 288]. This appears to require an O(n³) algorithm. In fact, if the obvious 4n products are precalculated, it can be calculated in O(n²) steps [Rabin, “Efficient Dispersal of Information for Security, Load Balancing, and Fault Tolerance”, JACM 36:2, 1989, pp. 335-348]. Note that since the products do not change such precalculation has to be done only once.

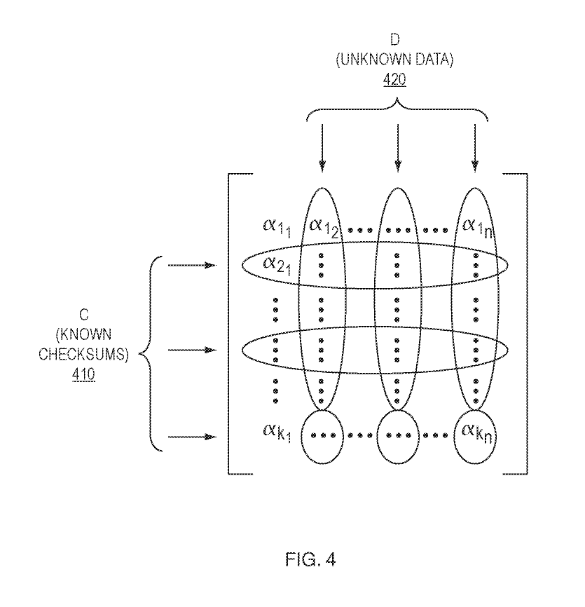

A conceptual diagram of a preferred embodiment of the process of finding the Cauchy submatrix, given known checksums C 410 and unknown data points D 420, is depicted in FIG. 4. It will be clear to one of skill in the art of the invention that other matrices also satisfy the condition that every submatrix is invertible, such as, but not limited to, Vandermonde matrices, and thus are suitable for use in the present invention, and also that other suitable methods for finding the submatrix may be similarly employed.

Constraints. There are two choices for the field in which all of the arithmetic for the checksums is performed. It can either be the real numbers or some finite field. The problem with choosing the real numbers is that Cauchy matrices are known to have explosively large condition numbers, and hence roundoff error will make the calculations impractical. In the preferred embodiment, the arithmetic is performed in the finite field F_{q}, since that can be done exactly. If the matrix A of section 3 is generated by n+k elements, a field with at least n+k distinct elements is needed, since no two elements generating the Cauchy matrix may sum to zero. Ideally the field elements should be storable in an integral number of bytes. Two plausible options are q=257 and q=2¹⁶. Today's computers essentially use finite field approximations for data storage, since precision is bounded.

Using a Galois field with 2^{m} elements for some integer m gives great speed advantages, since addition can be replaced by XOR [Blomer et. al., “An XOR-Based Erasure Resilient Coding Scheme”, Technical Report of the ICSI TR-95-048 (1995)]. Multiplication can be performed using a pre-calculated logarithm table. There exists a non-zero element b in the field with the property that 2^{m}−1 is the smallest positive value of n for which bⁿ=1. That value can be found by experiment, and can be used as a base for a table of logarithms. In the particular case of F₂_{¹⁶}, as it has been coded in a preferred embodiment, b=2.

In a prototype implementation, the parameters are set such that xᵢ=i and yᵢ=n+i in the Cauchy matrix. Suppose it is desired to have the flexibility to expand the number of disks and the number of checksums. If M is the maximum possible number of checksums, then in this case, it might be more realistic to set yᵢ=i and xᵢ=M+i.

It is simpler to program using a field with p elements where p is prime. In that case addition, subtraction, and multiplication take simple forms, and division can be calculated by multiplying inverses, and inverses can be calculated in advance and stored in a look up table. In particular, x(+)y=(x+y) % p, x(−)y=x−y % p, x(*)y=(x*y) % p, and x(/)y=x(*)y⁻¹.

x⁻¹ may be calculated by sequentially calculating x^{k}, k=1, . . . , p and recalling that if xⁿ=1, then xⁿ⁻¹=x⁻¹. It is known that x^{p-1}=1 for every x in the field, so this method always works. Just calculate once and store the results in a table. Any prime q>256 works well, since that enables coding of one ASCII character in one number.

Random Errors. If it is known that errors are independent and occur with probability p, around

$$\frac{np}{1 - p}$$

checksums are needed on average. Due to variance, several more checksums are preferably required to account for variability. When n is large and the errors are independent and identically distributed, a normal approximation can be used. The number of errors with pieces of data is approximately normal with mean mp and variance mp(1−p)≈mp when p is small. If χ_{β} is the β percentage point for a standard normal (e.g., 3 corresponds to 1/1000), then no fewer than m−mp−χ_{β}\sqrt{mp} correct transmissions are expected with probability 1−β. Solve for n=m−mp−χ_{β}\sqrt{mp}; then m−n is the proper number of checksums. In most cases, np+χ_{β}\sqrt{np} will be an adequate approximation.

An approximation for the case when n is small is also needed. Suppose there are n data points and k checksums. Failure occurs if more than k of the n+k points fail to be transmitted. The probability of failure is then

$${\sum }_{j = 1}^{n} ( \begin{matrix}n + k \\ j + k\end{matrix} ) {{p}^{j + k} ( 1 - p )}^{n - ( j + k )} \leq {p}^{k} {\sum }_{j = 1}^{k} ( \begin{matrix}n + k \\ j + k\end{matrix} ) {p}^{j} \leq \frac{{np}^{k + 1}}{1 - p} ( \frac{\begin{matrix}n + k \\ n + k\end{matrix}}{2} ) \leq \frac{{np}^{k + 1}}{1 - p} \frac{n + k}{2} ( \frac{n + k}{2} + 1 ) !$$

When p≦n⁻¹, a tighter inequality can be achieved. Recalling the equation:

$$( \begin{matrix}n + k \\ k + j + 1\end{matrix} ) = \frac{n - ( j + 1 )}{k + j + 1} ( \begin{matrix}n + k \\ k + j\end{matrix} )$$

### Then:

$${{\sum }_{j = 1}}^{n} ( \begin{matrix}n + k \\ j + k\end{matrix} ) {{p}^{j + k} ( 1 - p )}^{n - ( j + k )} \leq {p}^{k} {\sum }_{j = 1}^{n} {p}^{j} ( \begin{matrix}n + k \\ j + k\end{matrix} ) = {p}^{k} ( \begin{matrix}n + k \\ k + 1\end{matrix} ) {\sum }_{j = 1}^{n} {p}^{j} {\sum }_{i = 1}^{j} \frac{n - i}{k + i + 1} \leq {p}^{k} ( \begin{matrix}n + k \\ k + 1\end{matrix} ) \frac{n}{k + 2}$$

For example, if p=10⁻³ and one takes n=5 and k=3, then the bound is around 7*10⁻⁸.

Faster Checksums. Again suppose that n is large. Restoring each missing piece of data requires that touching all approximately n(1−p) pieces of data. It would be preferable to reduce this number. In addition to regular checksums, fast checksums may be made as follows. Divide the n data points into n/b blocks containing b points each (ignore fractions throughout this analysis). Constrain b by requiring bp≈1. Make two checksums in each block so that up to two errors may be restored. If only fast checksums need to be decoded in a block, then decoding each checksum requires touching only b points. It follows that one fast checksum may be decoded for each block in the time it takes to decode one slow checksum.

Approximate the number of errors in a block with a Poisson random variable with mean 1. The probability of more that 2 errors in a block is

$$\frac{e - 2.5}{e} \approx 0.08 .$$

The expected number of errors in a block with more than 2 errors is

$$\frac{e - 2}{e - 2.5} \approx 3.29 .$$

If the two fast checksums can be used in addition to supplement the slow checksums on bad blocks, then fewer than two slow checksums are needed and the speed of decoding is considerably increased (the two examples that follow yielding around tenfold and thirtyfold increases). In fact, the fast checksums may be used with very high probability.

Inverting the checksum matrix. Let γᵢ^{j}, j=1, . . . , n denote a Cauchy matrix. For blocks Bⱼ, j=1, . . . , n/b define the functions βⱼ(i)=1 if iεBⱼ, and otherwise βⱼ(i)=1. Fast checksums are defined by Σⱼ(i)γᵢ^{k}xᵢ and slow checksums by Σᵢ^{k}xᵢ. Considering the simplest possible case, one fast checksum being calculated per block, and only one block having multiple errors. After subtracting out the known values, the problem is restricted to a single block, where the β values are identically 1. It follows that in this case only a normal Cauchy matrix needs to be inverted.

Proceed by induction. Suppose that the matrix obtained from b−1 blocks is invertible, and now consider the case where b blocks have too many errors. Suppose block i has eᵢ where eᵢ>f, the number of fast checksums per block. Set E=Σeᵢ. Subtract out all of the known values, and obtain a matrix equation of the form C_{b}x=c, where C_{b} is a known E×E matrix, x is the vector of unknowns of length E, and c is the vector of computed checksums of length E.

The matrix C_{b} has a block structure. Each block submatrix B_{i,j} has dimension eᵢ×eⱼ. When i=j it consists of a Cauchy matrix. When i≠j the first f rows are 0 and the remainder are elements of a Cauchy matrix. To perform the inductive step, write

$${C}_{b} \underline{= ( \begin{matrix}{C}_{b - 1} & Q \\ R & {B}_{b , b}\end{matrix} )}$$

where Q is the singular E−e_{b}×e_{b} matrix of B_{i,b}, i=1, . . . , b−1, and R is the singular e_{b}×E−E_{b} matrix of B_{b, j}, j=1, . . . , b−1. The inductive hypothesis is that C_{b-1} is invertible. Let S=B_{b,b}−RC_{b-1}⁻¹ Q be the Schur complement of C_{b-1} is known that C_{b} is invertible if and only if S is invertible, in which case

$${C}_{b}^{- 1} = ( \begin{matrix}{C}_{b - 1}^{- 1} + {C}_{b - 1}^{- 1} {QS}^{- 1} {RC}_{b - 1}^{- 1} & - {C}_{b - 1}^{- 1} {QS}^{- 1} \\ - {S}^{- 1} {RC}_{b - 1}^{- 1} & {S}^{- 1}\end{matrix} )$$

A simpler technique can be used, as follows: Let M={m₁, . . . , mₙ} be a linearly independent set of vectors which span Rⁿ, and let C={c₁, . . . , cₙ} be a set of vectors satisfying mᵢ^{T}cⱼ=δ_{i,j}. Call C a vector inverse of M. Let Q={m₁, . . . , mₙ₋₁, qₙ}. Set μₙⁱ=qₙ^{T}cᵢ. If μₙⁿ≠0, then when i<n, set

$${v}_{n}^{i} = - \frac{{μ}_{n}^{i}}{{μ}_{n}^{n}} ,$$

and set

$${q}_{n} = {\sum }_{i = 1}^{n} {μ}_{n}^{i} {m}_{i} ,$$

### Then

$${v}_{n}^{n} = \frac{1}{{μ}_{n}^{n}} .$$

and if μₙⁿ≠0, then q has a vector inverse, and Q⁻¹={c₁+νₙ¹cₙ, . . . , cₙ₋₁+νₙⁿ, νₙⁿcₙ}. In a preferred embodiment, M is the regular Cauchy matrix and C is its inverse. The relevant vectors of the Cauchy matrix can be sequentially replaced with the modified blocked matrix and its inverse can be sequentially calculated.

Speed. The main cost of decoding checksums when the probability of error is small is the cost of subtracting out the known data. One fast checksum can be decoded in every group for the cost of calculating one slow checksum. There is a subsidiary cost, and that is the cost of multiplying the residue by the inverse Cauchy (or block Cauchy) matrix. This is also smaller for the fast checksums in good blocks, since they require a much smaller matrix to work with (the cost of calculating the matrix inverse is always negligible, since it is used many times and calculated only once). The cost of multiplying the residues of fast checksums in bad blocks is also less, since the inverse block Cauchy matrix has large regions of zeros. Since the cost is very small compared with calculating the residues, it can be ignored.

In general, it is expected that np checksums will be used, for a total time of n²p. If two fast checksums are used per block, this will reduce to around 0.1×n²p+2n. If three fast checksums are used, this will reduce to around 0.035×n²p+3n. If n is appreciably larger than p, this can yield significant time savings at a modest cost in space.

For example, suppose p=10⁻², and 1000 blocks of 100 elements each and 2 fast checksums per block and 1100 slow checksums are used. It is expected to find around 920 good blocks with no more than 2 errors each, and 80 bad blocks where checksums need to be combined. It can be expected that there will be around 264 total errors in these bad blocks. Around 736 fast checksums are used in good blocks and 160 fast checksums are used in the bad blocks. All together these take around as much time to decode as 1 slow checksum, 104 of which are used. The result is that, rather than decoding 1000 slow checksums, the equivalent of 105 slow checksums are decoded, resulting in a tenfold decrease in time.

Alternatively, suppose 3 checksums are used per block. It can be expected that there will be 981 good blocks with no more than 3 errors each, and 19 bad blocks checksums need to be combined. Around 81 total errors are expected in these bad blocks. Around 919 fast checksums are used in good blocks and 57 fast checksums are used in the bad blocks. All together these take around as much time to decode as 1 slow checksum, 34 of which are used. The result is that rather than decoding 1000 slow checksums, the equivalent of 35 slow checksums are decoded, resulting in a twenty eight-fold decrease in time.

Nodal checksums. Consider another use of these fast checksums. Suppose the data are stored in correlated clusters that have faster communications within a cluster. For example, a subnode might be on a common circuit, and a node might be in a common building. Some checksumming can be performed at the subnode level and the node level for speed advantage, and some checksumming can be performed between nodes for slower but more secure protection of data.

Vector Spaces of Numbers. If each character of an ASCII file is coded separately, the data is represented not as a single number, but as a vector of numbers. Each component of the vector can be coded as above, using the same matrix A every time. The same matrix is always obtained for decoding, and it will be necessary to invert it only once per transmission, no matter how long the vector is. Essentially the file is divided up into a set of numbers whose concatenation is the original file (in whatever encoding the computer is using). Each of these is treated independently.

Reassembling a User's Files. Once a file is stored, a way to find it and reassemble it is required. Two typical paradigms known in the art are “pulling” and “pushing”. Pulling involves having a central control that remembers where the file is stored and collects it. Pushing involves sending a request for the file and expecting it to come streaming in on its own. Each paradigm has its problems. The problem with pulling is that if the central index (or the pointer to the central index) is lost, then so is the file. The problem with pushing is that it requires querying many extra disks and storing certain extra information. It is expected that the extra information and the data transferred during queries is small compared with the cost of transferring files, so pulling is considered first.

In a preferred embodiment, the “central index” is a distributed hash table that is itself fault resilient and has data that is itself encoded and spread redundantly among computers. This means that that there is no central point of failure. A preferred application uses a distributed hash table (DHT) to achieve this distribution, but it will be clear to one of skill in the art of the invention that other methods can also be used. DHTs have previously been used for non-reliable (best-effort) storage such as BitTorrent, but the application of a DHT to reliable distributed storage is novel.

In a preferred embodiment, each piece of a file is stored with the following information: userid, fileid, how many pieces/checksums the file is broken into, and which piece this is. This last will be a vector with n parameters; if the same checksum scheme is always used (i.e., matrix A), it can be an integer between 1 and n+k. This information is available to the disk controller. This assumes that when a disk fails, it fails completely. If the index of the disk can fail independently of the disk (for example, in a disk containing bad sectors), it is necessary to consider the whole disk as having failed. The alternative is a recursive scheme backing up the disk to itself. The user is defined by the userid; when the user logs on he broadcasts a request for his index file (which has a standardized name), which contains a list of his file names and their ids. He can then request files as he desires. In general, each file can be stored with different ‘metadata’ (i.e., information about the file), as the application requires. Such metadata may include, but are not limited to, modification date, owner, permissions, CRC, which set of files the current file belongs to, hashes used to prevent replication, and any other data that the system may find useful.

The details of how a broadcast is made can be complex. Suppose a typical network contains 10,000 nodes, and a typical file is stored on 100 disks. Some effort may be eliminated if it can be guessed which disks are likely to hold a particular file, such as through some chaotic function of the fileid, which is also called a hash code by computer programmers. A second issue is that it is preferable to fill disks more or less evenly. A greedy algorithm will work fine, but is not predictable, so that when requests are broadcast it isn't known where to look. A randomized algorithm will work almost as well, but it is desirable to include a seed with each fileid so it is known where it began to be stored. In a preferred application, using a DHT easily enables the system to find any given file. The exact number of disk accesses needed scales favorably (typically poly-logarithmically) with the number of computers in the system.

As previously mentioned, the present invention may particularly be advantageously applied to the problem of disk backup, providing an efficient means for distributed backup. There are other examples of distributed backup known in the art, such as, for example, CleverSpace, but they use different approaches. In this application, instead of storing data on the disk drive of the user's machine, a community of cooperating devices is employed. When data is written to the disk drive, it is sliced into smaller pieces, checksummed using the Cauchy Matrix-based methods of the present invention and distributed among the disk drives of the community. Now, if one of the users' network connections is interrupted or their disk has crashed, the stored data is still available. Thus, a user can never lose their data. In addition, it can be guaranteed that the user's data will be available so long as the community-wide failure rate stays below a particular level, a level that can be specified according to the demands of the particular community. This therefore provides a system with much better reliability than traditional backup systems that simply hold the data in two locations. Furthermore, with a reasonable network connection, the speed of retrieval can be faster than a disk controller, since the data is coming from multiple sources and, as Hartman and Ousterhout point out [John H. Hartman, John K. Ousterhout, The Zebra Striped Network File System, ACM Transactions on Computer Systems (TOCS), Volume 13, Issue 3 (August 1995) 274-310], such an approach performs better than typical disk controllers. Essentially, it will no longer be necessary to backup data, since the nature of the way the data is stored assures its integrity, even in the presence of unreliable hardware. If the system has a bounded rate of failure, it is possible to proactively correct errors. This means that even if the total number of failures is extremely large, all of the data is recoverable as long as the number of failures in any given time frame is bounded.

While a particular example system is discussed, it will be clear to one of skill in the art that it is illustrative only, and that there are myriad possible implementations and examples. Applying the specific example analysis discussed previously to the problem of disk backup, suppose there are d disks, it is expected that no more than k of them to fail, and it is desired to back them all up. Partition the contents of each disk into n equal parts, and calculate k checksums. Each part is, of course, a vector. As long as k+n<d, each part or checksum may be stored on a separate disk, which guarantees against loss of data. The cost of this scheme is extra storage and overhead. If things are arranged so that the location of files is transparent to the user, it is not necessary to have two copies of the n pieces of data. In that case, the cost is the size of the k checksums, which is k/n of the total disk space originally used. Obviously, the larger n is the smaller this number is, and the tradeoff will be against the overhead costs (bookkeeping and restoring files).

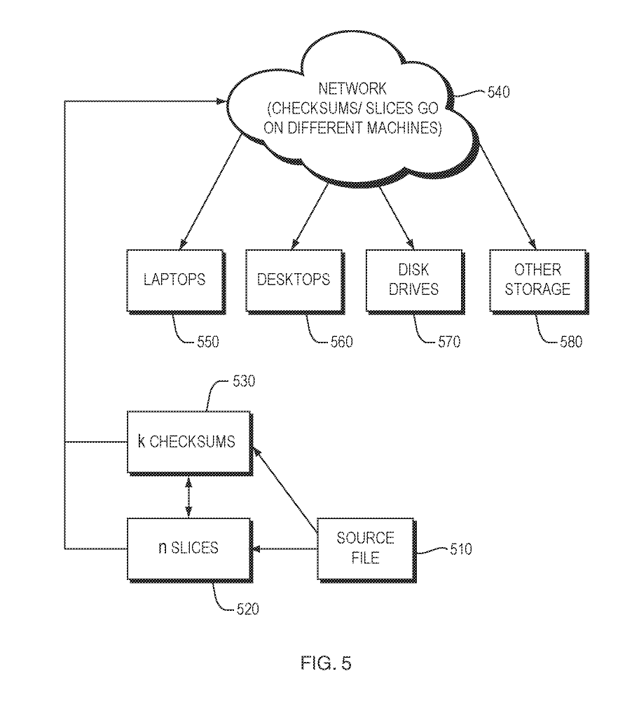

FIG. 5 is a block diagram illustrating an embodiment of the process of dispersing data slices in a network. In FIG. 5, source file 510 is sliced into n slices 520 and k checksums 530 are calculated. Data slices 520 and checksums 530 are then sent over network 540 and stored across various laptop computers 550, desktop computers 560, disk drives 570 and/or other suitable storage devices 580.

The present invention may also be advantageously applied to the problem of database reliability. A database is a file that is edited piece by piece. One of issues with the use of matrix-based codes is that the algorithms are designed for the storage and retrieval of large files may not be efficient for databases where small amounts of data is stored and retrieved, as in the case where a single record is added or modified. There are two general solutions to this problem: a modification of the matrix-based codes or evaporation. By using fewer checksums and slicing the files up differently, small files may be efficiently read and written. This permits large database systems to be constructed from commodity hardware and extended simply by adding more storage. Such a design is extensible, redundant, and fault tolerant, in that drives can be removed and added at will without interruption.

The other solution to writing small files, evaporation, also has many other applications. In evaporation, rather than rewriting new data to existing files, when a file is rewritten it is simply written again in another location and the previous file is left as is. The directory of the file system is updated to reflect the new location of the file. Unless the file has some explicit policy associated with it, it remains in the distributed file system. Based on a defined policy, such as, for example, files that are marked as a candidate for deletion or files that have not been accessed or modified for a particular period of time, files are evaporated and can be replaced. Files that need to be maintained are marked as such and will persist. Evaporation can easily be run as a separate process in the background. The feasibility of this process is a side effect of the fact that disk storage is now very cheap and the methods of the present invention are much more efficient than prior art mirrors or other coding methods, so that the cost is not overwhelming. Evaporation can be thought of as the equivalent of garbage collection for managing memory.

For simplicity, assume that each database piece is the same size. Effective backup has been obtained by this invention with minimum extra space for normal files by distributing them over many disks with independent errors. The cost was that each disk had to be read every time the file was filed. In an alternative embodiment, appending to a file may be used and may be considerably less expensive. In general, more “expensive” (e.g., storage intensive) backup techniques are generally preferred if they require fewer reads and writes to obtain or change single elements of the database. Yekhanin [“New Locally Decodable Codes and Private Information Retrieval Schemes”, Electronic Colloquium on Computational Complexity, Report No. 127 (2006)] reviews algorithms for database reliability. The problem Yekhanin addresses is the amount of space required to obtain, with high probability, a correct answer from a small, fixed number of queries. He claims that, for a database of length m, such an algorithm requires more than O(m^{1+δ}) space, assuming that the probability of error remains fixed, but the size of the database is increased.

The present invention is different in at least two respects. First, it is assumed that which data are erroneous is known. Second, rather than having a fixed number of queries, a random number are allowed, with small expectation. In that case, O(m) space is needed to solve Yekhanin's problem, and O(m log m) space is needed to have high probability that of recovering every element of the database. The algorithm is: Let ε>0 be the total possible allowable error. Select n such that p<n⁻¹ (in the worst case we'll need n=1). Group the m=g*n data points into g groups each containing n points. Checksum each group with k checksums. The probability of error for a query of a single datum is bounded by

$$f ( k ) = {p}^{k} ( \begin{matrix}n + k \\ k + 1\end{matrix} ) \frac{n}{k + 2}$$

Notice that f(k) does not depend on g, and that

$${lim}_{k -> ∞} f ( k ) \leq {lim}_{k -> ∞} {{p}^{k} ( n + k )}^{n} = 0$$

Select k so that f(k)≦ε and then use k checksums for every n points of data, yielding

$$m + gk = m + \frac{mk}{n}$$

points in all, O(m) space. It can be assumed that which data is erroneous is known due to over determination of the matrix inversion. Which data is erroneous could also be discovered by, for example, using a homomorphic encoding/signatures of the data pieces. It will be clear to one of skill in the art of the invention that any other method can be used to discover which pieces are incorrect.

As for time, with probability 1−p one query will suffice, and otherwise it is expected to need

$$\frac{k}{1 - p}$$

additional queries, a total expected value of

$$1 + \frac{kp}{1 - p} .$$

In the event that the initial query fails (probability p), an O(k²) time algorithm will also be needed to invert the matrix needed to decode the checksums.

Suppose that it is desirable to know the probability that all the queries asked turn out correct. In that case, the probability of error is

$$f ( g ) = {gp}^{k} ( \begin{matrix}n + k \\ k + 1\end{matrix} ) \frac{n}{k + 2}$$

Set k=α log g and write

$$f ( g ) = {gp}^{k} ( \begin{matrix}n + k \\ k + 1\end{matrix} ) \frac{n}{k + 2} \leq exp ( log g + αlog g log p + n log ( n + log g ) ) \leq exp ( 1 + α log p ) log g + n log ( n + log g ) )$$

which converges to 0 as long as

$$α < \frac{- 1}{log p} .$$

The rest of the analysis is precisely as above. The only difference is that, since k=O(log m), O(m log m), space is needed.

Thus far, only consulting a database has been discussed. There is also a second operation: changing a database entry. To do this, it is necessary to change one entry and k checksums. To evaluate the new value of the k checksums, there are two options; one is to recalculate the checksums from scratch, and the other is to subtract out the contribution of the changed element, and to replace it with the contribution of the new element. This is an O(1) operation for each of the k checksums. In addition, some way to index the operation is required in order to find out where the data and its checksums are stored. Conceptually this is a table; in practice, it should be a function of some sort so that it will not require appreciable space. A preferred application uses a DHT for this purpose.

The calculations of probabilities assume that every entry in the database is independent. Suppose, instead, that n+k disks are used, and one element of every group is stored on the same disk, so that all elements on one disk succeed or fail together. In that case the first calculation of probability of error is correct, even when m →∞. In particular, k may be taken as fixed. This provides an opportunity to implement distributed databases. Some kind of lock on the group of n+k data and checksums is required while one of them is being written, but there need be no such constraints when they are read, and there need be no constraints on the rest of the database. Such a lock is required only for consistency; if consistency is not desired then this can be ignored. The furnishing of such locks can be thought of as a service to programs desiring to use this invention for distributed computation.

A possible embodiment of the system assumes that files will be distributed among disks scattered throughout the network. This requires extra security, both from malicious and accidental corruption. Several possible security devices would be suitable for files. One is a cryptographic hash that depends on the entire file, so that it is known if the file has been changed. Another is a public/private key for encoding the file so that it can't be read by anyone unauthorized. And a third is a header describing the file in some detail. It may optionally be desirable to include pointers to other pieces of the same file. At first glance it might seem that it is not possible to obtain a self-proving file; that is, the hash can't be part of the file. That changes, though, if the hash can itself be coded, e.g., by artfully interspersing a password into the file to be hashed. In order to use the cryptographic hash, an index file that contains the previously calculated hashes of all the slices of all the files belonging to the user is used. It will be clear to one of skill in the art of the invention that any other cryptographic method may be utilized to ensure privacy and security of data.

The present invention may also be advantageously applied to the problem of restoring tracks on a single disk. A major problem with disk drives is that they fail and recovery can be long and costly, sometimes costing thousands of dollars to repair. The user faced with loss of data is often willing to pay almost anything for the disk to be repaired. There are many failure modes for disk drives, including head crashes, circuit card problems, alignment, and media deterioration. Some disk failures are catastrophic. Others, however, damage only certain tracks on a hard disk. One major failure mode is for the head on a multi-platter drive to “go open”, i.e. the head fails. In that instance, one whole platter of the drive is lost; however, the rest of the disk platters still work. Scratches on a CD or DVD are conceptually similar. The principles embodied in the present invention may be advantageously used to design a self-restoring hard disk, as well as a CD/DVD that is resistant to scratches.

For example, if the drive uses matrix-based codes and slices what is written to the disk so that it is split among platters, then if any one platter, or even multiple platters, fail, data written to the disk can be recovered without opening the disk and replacing the head. This accomplished by simply writing slices to each platter in a manner such that data can be recovered if any one platter is lost. In fact, this repair can be performed without requiring user intervention. The cost is an amount of additional storage necessary for the checksums, but if there are a reasonable number of platters, this would be small, being on the order of the inverse of the number of platters. There is an additional cost in read only storage that after failure data access will be slightly slower. This approach can also be used to protect against both hard and soft disk errors that occur on a sector-by-sector basis. In such an instance, data is written and read in ensembles and these are distributed on the disk, in different places on a single platter and/or on different platters. If there are hard or soft errors, the disk can still be recovered.

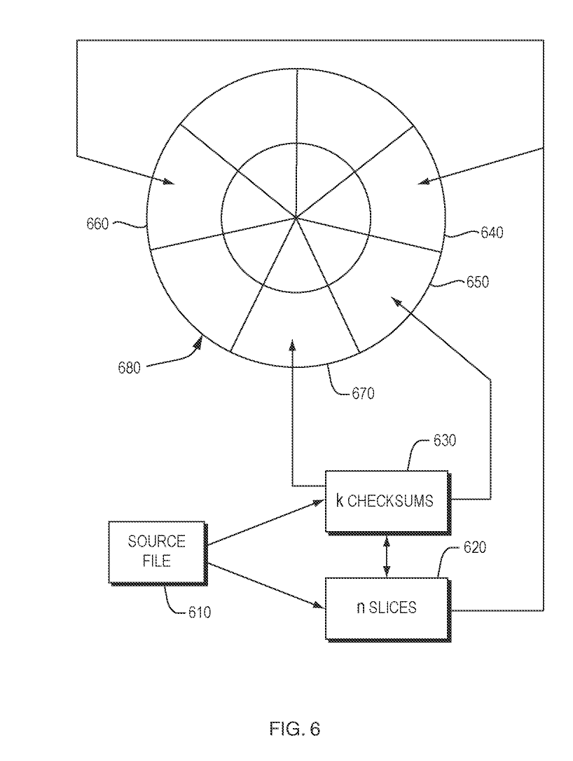

FIG. 6 is a block diagram illustrating an embodiment of the process of dispersing data slices on disk tracks according to this aspect of the present invention. In FIG. 6, source file 610 is sliced into n slices 620 and k checksums 630 are calculated. Data slices 620 and checksums 630 are then stored in separate sectors 640, 650, 660, 670 of hard drive 680.

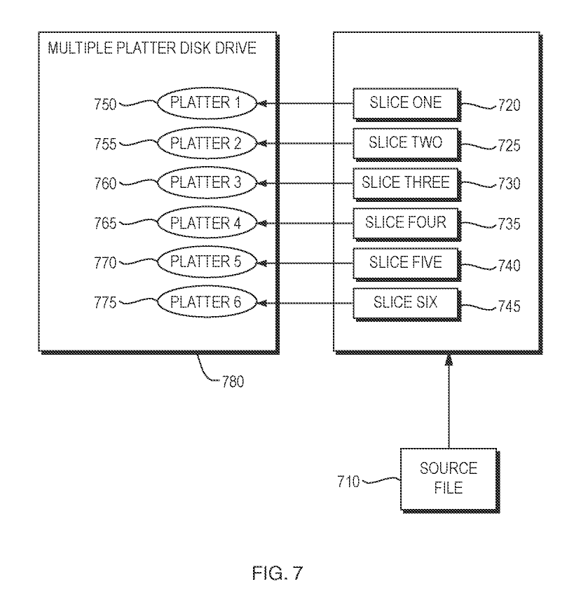

FIG. 7 is a block diagram illustrating an embodiment of the process of dispersing data slices onto the platters of a multiple platter disk drive. In FIG. 7, source file 710 is sliced into data slices 720, 725, 730, 735, 740, 745, which are then stored on separate platters 750, 755, 760, 765, 770, 755 of multiple platter disk drive 780

Time and Space Costs. Suppose a large file has been coded, so that the overhead of inverting the Cauchy matrix is negligible (of course the cost can be negligible for small files also if it is precalculated). In particular, say that the file is of length nv. The cost of inverting each checksum is then n multiplications and n subtractions. In a preferred embodiment, the multiplication has been coded as a look up table so that each of these operations take around the same time. It follows that each checksum takes 2n time to be decoded. It is expected that np disks will be lost, and hence it is expected that vnp checksums will be decoded, and thus the time of decoding is proportional to vn²p.

Time may be saved by adding extra checksums. Suppose, for example, that the n disks are grouped into subgroups of 1/p (round down). Calculate 3 checksums for each subgroup. Checksums over the entire group of n disks are also required. If p is small enough (say p<0.2), the number of errors among a subgroup may be approximated by a Poisson with mean 1. If X is a Poisson with mean 1, the probability that it is greater than 3 is

$$1 - {e}^{- 1} ( 1 + 1 + \frac{1}{2} + \frac{1}{6} ) < 0.02 .$$

At the boundary, when p=0.2, the exact value is less than 0.007, well below the Poisson approximation.

It follows that more than 98/100 of the groups can be decoded in time 1/p rather than time n. The remaining groups will have disproportionately large numbers of checksums. If X represents a Poisson with mean 1 the expected value is E(X|X≧3)≦3.3. It follows that the total time for decoding checksums will be proportional to v(n+0.02*3.3n²p). To pick a reasonable example, suppose p=0.01 and n=10⁴. Using the regular system, it is expected that the decoding time will be proportional to v10⁶. Using the system of the present invention, that is reduced to v(10⁴+0.06610⁶)=3v10⁴, a seven fold reduction. For fixed p, as n gets large, the limit is more than a fifteen fold reduction.

Further, while 3np of the fast checksums are needed, the full quota of np+χ\sqrt{np} slow checksums is not needed, since more than 98/100 of the groups will be preempted by the fast checksums. Instead, only 0.066np+χ\sqrt{np} slow checksums are needed. In addition, slow checksums are added to account for the loss of checksums due to disk failures. The tripled checksums need not be duplicated; instead only an additional

$$\frac{p}{1 - p} ( np + χ \sqrt{np} )$$

slow checksums are needed.

As an example, suppose it has been decided to have three checksums per group. What would be the optimal group size? It is desirable to set it so the probability of more than three errors was small. In other words, if λ is the mean of the Poisson, it is desirable to pick λ to minimize

$${e}^{- λ} ( 1 + λ + \frac{{λ}^{2}}{2} + \frac{{λ}^{3}}{6} ) .$$

This requires solving the equation λ⁴+3λ3+3λ²−6=0. The solution is around 0.95, and reduces the probability from around 0.019 to around 0.017. It follows that a slightly better limiting speed up (from around 15 to around 18) will be obtained if groups of size 0.95/p are taken.

The number of checksums per group may also be changed. At λ=1, the marginal value of the fourth checksum is small. In general, however, given a number of checksums, it is necessary to redo the optimization. For example, if only two checksums are desired, the optimal value is around 0.85/p. This gives a limiting speedup of 11, whereas a group size of 1/p gives a limiting speedup of 7.8. A particular advantage of the present invention is that these calculations may be performed in parallel, speeding up the computation and permitting it to be run in distributed and multi-core systems. Although the above discussion focuses on two types of checksums (fast and slow), it is clear to one skilled in the art that multiple levels of checksums may be advantageously employed in the present invention.

Comparison With Standard Results. These results compare favorably with Luby's Tornado codes [Luby et. al., “Efficient Erasure Correcting Codes”, IEEE Transactions on Information Theory 47:2, (2001) 569-584]. Tornado codes take n log n time, and the procedure of the present invention will therefore be faster if n²p²=O(1), or

$$p = O ( \frac{1}{n} ) .$$

Ease of implementation also argues for use of the present invention in marginal cases. In addition, tornado codes have a positive probability of failure.

In particular, changing the database is fast, being only a O(k) operation. When only n+k disks are used, the probability of an error somewhere in the system decreases). The present invention therefore needs only O(n) to solve Yekhanin's problem of minimizing the probability that a single query will yield an incorrect answer. O(n log n) is required for the stronger claim that every database element is recoverable. Tables 1-3 present bounds on probabilities for 1 to 10 data points and checksums per group using the present invention, for probability of error 1/10, 1/100, and 1/1000.

Table 1 for bound on probability of error 0.1

| | checksums | | | | | | | | | |
|---|---|---|---|---|---|---|---|---|---|---|
| data | 1 | 2 | 3 | 4 | 5 | 6 | 7 | 8 | 9 | 10 |
| 1 | 0.03 | 0.003 | 0.0002 | 2.00E−05 | 1.00E−06 | 1.00E−07 | 1.00E−08 | 1.00E−09 | 9.00E−11 | 8.00E−12 |
| 2 | 0.2 | 0.02 | 0.002 | 0.0002 | 2.00E−05 | 2.00E−06 | 2.00E−07 | 2.00E−08 | 2.00E−09 | 2.00E−10 |
| 3 | 0.6 | 0.08 | 0.009 | 0.001 | 0.0001 | 1.00E−05 | 2.00E−06 | 2.00E−07 | 2.00E−08 | 2.00E−09 |
| 4 | 1 | 0.2 | 0.03 | 0.004 | 0.0005 | 6.00E−05 | 7.00E−06 | 9.00E−07 | 1.00E−07 | 1.00E−08 |
| 5 | 2 | 0.4 | 0.07 | 0.01 | 0.002 | 0.0002 | 3.00E−05 | 4.00E−06 | 5.00E−07 | 6.00E−08 |
| 6 | 4 | 0.8 | 0.2 | 0.03 | 0.004 | 0.0006 | 9.00E−05 | 1.00E−05 | 2.00E−06 | 2.00E−07 |
| 7 | 7 | 1 | 0.3 | 0.05 | 0.009 | 0.002 | 0.0002 | 4.00E−05 | 5.00E−06 | 7.00E−07 |
| 8 | 10 | 2 | 0.5 | 0.1 | 0.02 | 0.003 | 0.0006 | 9.00E−05 | 1.00E−05 | 2.00E−06 |
| 9 | 10 | 4 | 0.9 | 0.2 | 0.04 | 0.007 | 0.001 | 0.0002 | 4.00E−05 | 6.00E−06 |
| 10 | 20 | 6 | 1 | 0.3 | 0.07 | 0.01 | 0.003 | 0.0005 | 8.00E−05 | 1.00E−05 |

Table 2 for bound on probability of error 0.01

| | checksums | | | | | | | | | |
|---|---|---|---|---|---|---|---|---|---|---|
| data | 1 | 2 | 3 | 4 | 5 | 6 | 7 | 8 | 9 | 10 |
| 1 | 0.003 | 3.00E−05 | 2.00E−07 | 2.00E−09 | 1.00E−11 | 1.00E−13 | 1.00E−15 | 1.00E−17 | 9.00E−20 | 8.00E−22 |
| 2 | 0.02 | 0.0002 | 2.00E−06 | 2.00E−08 | 2.00E−10 | 2.00E−12 | 2.00E−14 | 2.00E−16 | 2.00E−18 | 2.00E−20 |
| 3 | 0.06 | 0.0008 | 9.00E−06 | 1.00E−07 | 1.00E−09 | 1.00E−11 | 2.00E−13 | 2.00E−15 | 2.00E−17 | 2.00E−19 |
| 4 | 0.1 | 0.002 | 3.00E−05 | 4.00E−07 | 5.00E−09 | 6.00E−11 | 7.00E−13 | 9.00E−15 | 1.00E−16 | 1.00E−18 |
| 5 | 0.3 | 0.004 | 7.00E−05 | 1.00E−06 | 2.00E−08 | 2.00E−10 | 3.00E−12 | 4.00E−14 | 5.00E−16 | 6.00E−18 |
| 6 | 0.4 | 0.008 | 0.0002 | 3.00E−06 | 4.00E−08 | 6.00E−10 | 9.00E−12 | 1.00E−13 | 2.00E−15 | 2.00E−17 |
| 7 | 0.7 | 0.01 | 0.0003 | 5.00E−06 | 9.00E−08 | 2.00E−09 | 2.00E−11 | 4.00E−13 | 5.00E−15 | 7.00E−17 |
| 8 | 1 | 0.02 | 0.0005 | 1.00E−05 | 2.00E−07 | 3.00E−09 | 6.00E−11 | 9.00E−13 | 1.00E−14 | 2.00E−16 |
| 9 | 1 | 0.04 | 0.0009 | 2.00E−05 | 4.00E−07 | 7.00E−09 | 1.00E−10 | 2.00E−12 | 4.00E−14 | 6.00E−16 |
| 10 | 2 | 0.06 | 0.001 | 3.00E−05 | 7.00E−07 | 1.00E−08 | 3.00E−10 | 5.00E−12 | 8.00E−14 | 1.00E−15 |

Table 3 for bound on probability of error 0.001

| | checksums | | | | | | | | | |
|---|---|---|---|---|---|---|---|---|---|---|
| data | 1 | 2 | 3 | 4 | 5 | 6 | 7 | 8 | 9 | 10 |
| 1 | 0.0003 | 3.00E−07 | 2.00E−10 | 2.00E−13 | 1.00E−16 | 1.00E−19 | 1.00E−22 | 1.00E−25 | 9.00E−29 | 8.00E−32 |
| 2 | 0.002 | 2.00E−06 | 2.00E−09 | 2.00E−12 | 2.00E−15 | 2.00E−18 | 2.00E−21 | 2.00E−24 | 2.00E−27 | 2.00E−30 |
| 3 | 0.006 | 8.00E−06 | 9.00E−09 | 1.00E−11 | 1.00E−14 | 1.00E−17 | 2.00E−20 | 2.00E−23 | 2.00E−26 | 2.00E−29 |
| 4 | 0.01 | 2.00E−05 | 3.00E−08 | 4.00E−11 | 5.00E−14 | 6.00E−17 | 7.00E−20 | 9.00E−23 | 1.00E−25 | 1.00E−28 |
| 5 | 0.03 | 4.00E−05 | 7.00E−08 | 1.00E−10 | 2.00E−13 | 2.00E−16 | 3.00E−19 | 4.00E−22 | 5.00E−25 | 6.00E−28 |
| 6 | 0.04 | 8.00E−05 | 2.00E−07 | 3.00E−10 | 4.00E−13 | 6.00E−16 | 9.00E−19 | 1.00E−21 | 2.00E−24 | 2.00E−27 |
| 7 | 0.07 | 0.0001 | 3.00E−07 | 5.00E−10 | 9.00E−13 | 2.00E−15 | 2.00E−18 | 4.00E−21 | 5.00E−24 | 7.00E−27 |
| 8 | 0.1 | 0.0002 | 5.00E−07 | 1.00E−09 | 2.00E−12 | 3.00E−15 | 6.00E−18 | 9.00E−21 | 1.00E−23 | 2.00E−26 |
| 9 | 0.1 | 0.0004 | 9.00E−07 | 2.00E−09 | 4.00E−12 | 7.00E−15 | 1.00E−17 | 2.00E−20 | 4.00E−23 | 6.00E−26 |
| 10 | 0.2 | 0.0006 | 1.00E−06 | 3.00E−09 | 7.00E−12 | 1.00E−14 | 3.00E−17 | 5.00E−20 | 8.00E−23 | 1.00E−25 |

As discussed before, Luby claims that deterministic codes are much slower than Tornado codes. However, Luby assumes that he is working with systems with a high number of errors. In reality, many applications have a much smaller number of errors and there is consequently a much lower speed penalty. Tests of a “basic” prototype implementation show very little cost with the use of the codes described herein, and a number of improvements can increase the speed advantage up to fifteen times over the codes used by Luby in his tests. Essentially, while current codes are faster to reconstruct data when errors are corrected, they are slower when there are no errors. Fortunately, the case where there are no errors is much more likely and so the present invention takes advantage of this fact.

Table 4 presents example results from timing tests of the basic prototype implementation of the error correction methods of the present invention. The tested prototype employs the base version of the codes of the present invention, without several of the possible efficiency improvements. The cost of encoding depends linearly on the number of checksums to be computed. The decode speed is independent of the number of checksums that exist; instead it is dependent on the number of checksums used.

TABLE 4
testing 112 slices with 16 checks 0 reconstructions over 146800640 bytes: 10.0548 Mb/s encode, 299.593 Mb/s decode
testing 112 slices with 16 checks 1 reconstructions over 146800640 bytes: 10.0963 Mb/s encode, 62.2037 Mb/s decode
testing 112 slices with 16 checks 2 reconstructions over 146800640 bytes: 10.1242 Mb/s encode, 45.0309 Mb/s decode
testing 112 slices with 16 checks 3 reconstructions over 146800640 bytes: 10.0894 Mb/s encode, 35.8050 Mb/s decode
testing 112 slices with 16 checks 4 reconstructions over 146800640 bytes: 10.1452 Mb/s encode, 29.7167 Mb/s decode
testing 112 slices with 16 checks 5 reconstructions over 146800640 bytes: 10.0617 Mb/s encode, 26.1211 Mb/s decode
testing 112 slices with 16 checks 6 reconstructions over 146800640 bytes: 10.0205 Mb/s encode, 23.0095 Mb/s decode
testing 112 slices with 16 checks 7 reconstructions over 146800640 bytes: 10.0548 Mb/s encode, 20.1097 Mb/s decode
testing 112 slices with 16 checks 8 reconstructions over 146800640 bytes: 10.1172 Mb/s encode, 18.6769 Mb/s decode
testing 112 slices with 16 checks 9 reconstructions over 146800640 bytes: 10.0963 Mb/s encode, 17.0897 Mb/s decode
testing 112 slices with 16 checks 10 reconstructions over 146800640 bytes: 10.0963 Mb/s encode, 15.4365 Mb/s decode
testing 112 slices with 16 checks 11 reconstructions over 146800640 bytes: 10.1452 Mb/s encode, 14.5491 Mb/s decode
testing 112 slices with 16 checks 12 reconstructions over 146800640 bytes: 10.1382 Mb/s encode, 13.5176 Mb/s decode
testing 112 slices with 16 checks 13 reconstructions over 146800640 bytes: 9.99324 Mb/s encode, 12.6334 Mb/s decode
testing 112 slices with 16 checks 14 reconstructions over 146800640 bytes: 9.98644 Mb/s encode, 11.9156 Mb/s decode
testing 112 slices with 16 checks 15 reconstructions over 146800640 bytes: 10.0825 Mb/s encode, 11.1976 Mb/s decode

As an example, one of the preferred applications for the present invention is distributing files. Using the methods of the invention, a file is divided into numerous slices, and even if a number of slices of the file are missing, the file can still be recreated using the methodology of the invention. The present invention is not being used just for recovering data in extremely noisy channels, but also for storing and reading all data. In this example, if a file is distributed among a thousand disks, and if on average a disk fails every three years, then using the present invention only 0.1% additional storage is needed to ensure against loss of any data. Furthermore, larger amounts of redundancy will protect against larger failure rates and/or for longer periods of time. This presents a major advantage over prior art methods that require replication of the data at a cost of additional storage of 100%, 200%, or more. Furthermore, in this example, the computational costs and time for recovery are small and the system can continue to work while it reconstructs the lost data. Therefore, if a drive fails, it makes no difference in the read/write performance and there is very little cost for the background process to recover the drive.

A working prototype has been implemented that uses these erasure codes to encode and decode. It also distributes slices to (and retrieves slices from) nodes in a storage ring. Erlang was employed as a programming language for high-level implementation of the prototype embodiment, but it will be clear to one of skill in the art of the invention that many other programming languages are suitable. Erlang was chosen in part because it supports concurrency in at least five ways. First, it is a functional language, which eliminates the hazards of maintaining mutable state. Second, it allows for natural parallel programming with its extremely efficient process and message passing implementations. Third, it is a distributed concurrent language so that computations can be easily migrated to multiple hosts if they can bear the network latency. Fourth, it is engineered for highly available systems so it has mechanisms for error recovery and system restart. Fifth, it is engineered for non-stop systems so it has mechanisms for live code update and automatic fall back if the update fails. Erlang has proven itself as a suitable vehicle for massively parallel, distributed, scalable, highly available, non-stop systems in its use by Ericsson for telecommunication switches, ejabberd as a scalable instant messaging server, CouchDB as a web database server, Scalaris as a scalable key value store, and Yaws as a full featured web server.

In the prototype implementation, numerically intensive parts of the system, such as the erasure coding and decoding and cryptographic computations, use libraries and modules written in the C language. It will be clear to one of skill in the art of the invention that other programming languages would also be suitable. The prototype employs SHA-1 as the cryptographic hash function, but other cryptographic hash functions could be used instead. All or part of the system can be written in other programming languages, which may be desirable, for example, if those other languages are well suited to a particular client or server environment. For instance, an implementation of the client side file system code could be written in Javascript for use inside web browsers.

Tables 5 and 6 present example embodiments of code that implements the error correction methods of the present invention, in particular for computing checksums and encoding and decoding the data. While preferred embodiments are disclosed, it will be clear that there are many other suitable implementations that will occur to one of skill in the art and are within the scope of the invention. For example, in some applications it may be desirable to handle big/little endian issues without performing a byte swap.

TABLE 5
(ecodec.h)

/*
** externally supplied utilities for erasure codec and galois field
*/
extern int ecodec_fail(char *message);
/*
** the modulus of our galois field
*/
#define FMODULUS 256*256
/*
** outer limits on encoding sizes
*/

| | | |
|---|---|---|
| #define MAX_ROWS | 256 | /* maximum number of data slices */ |

| | | |
|---|---|---|
| #define MAX_COLS | 64 | /* maximum number of checksum slices */ |

/*
** galois field type definitions and function declarations
*/
typedef unsigned short ffelement; /* the field element is 16 bits */

| | |
|---|---|
| typedef unsigned int ffaccum; | /* an accumulator needs 17 bits */ |

extern void ffinit(void);
extern ffelement ffadd(ffelement x, ffelement y);
extern ffelement ffsub(ffelement x, ffelement y);
extern ffelement ffmul(ffelement x, ffelement y);
extern ffelement ffdiv(ffelement x, ffelement y);
extern unsigned short fflog(ffelement x);
extern ffelement ffexp(unsigned short x);
/*
** erasure code type definitions and function declarations
*/
/*
** terminology:
** the data presented for erasure coding will be sliced into nslice
** data slices augmented by ncheck checksum slices. In general a
** slice refers to a data slice.
** The length of each data and checksum slice might be considered
** the depth of the slices, it can range from a minimum of 2 up to
** some undetermined maximum. The size of a UDP datagram could be a
** limit on slice depth, but probably shouldn't.
*/
/*
** compute ncheck checksums for length bytes of data in nslice slices.
**
** data is an array of length bytes, where length / nslice = bytes_per_slice,
** length % nslice = 0, and bytes_per_slice is even.
**
** data is stored so slice[0] is at data[0], data[1], data[2], ...,
** data[bytes_per_slice-1].
**
** the encoded result, ret, is an array of ncheck * bytes_per_slice checksums.
** it is also stored so check[0] is at ret[0], ret[1], ret[2], ...,
** ret[bytes_per_slice-1].
**
** the data is in the order it is presented by the client for transmission, we
** slice it in row major order so that data slices are not made of contiguous
** data bytes.
*/
extern int ecencode(int nslice, int ncheck, int length, unsigned char *data, unsigned char *result);
/*
** recover the original data from nslice slices or checksums stored in length
** bytes of data.
**
** slice numbers identified in index, where 0 .. nslice-1 indicate data slices
** and nslice .. nslice+ncheck-1 indicate checksum slices
**
** the slices_or_checksums are presented in the order they were received,
** which may bear no relation to their natural order.
**
** and data contains the data of the slices so
** slice_or_checksum[index[0]] is at data[0], data[1], ...,
** data[bytes_per_slice-1].
**
** Hmm, this assumes that we've concatenated the received slices and
** checksums in the order received, and then reconcatenate in the
** correct order with the missing slices, if any, reconstructed.
**
** At the minimum, we simply permute the received slices into the
** correct order.
*/
extern int ecdecode(int nslice, int ncheck, int *index, int length, unsigned char *data, unsigned
char *result);

TABLE 6
(ecodec.c)

/*
** Implement erasure coding and decoding
**
** Coded by Roger E Critchlow Jr, February 2008
** based closely on code by David Riceman, July-August 2007
**
*/
#include <stdio.h>
#include <string.h>
#include “ecodec.h”
/*
** galois field order2\hat{ }16
** possible primitive polynomials written in octal
** 210013, 234313, 233303, 307107, 307527, 306357,
** 201735, 272201, 242413, 270155, 302157, 210205,
** 305667, 236107
**
** sources for information about finite fields and arithmetic over
** finite fields:
**
** http://en.wikipedia.org/wiki/Finite_field
** http://en.wikipedia.org/wiki/Finite_field_arithmetic
** Galois Field Arithmetic Library C++:

| | |
|---|---|
| ** | http://www.partow.net/projects/galois/index.html |

** Fast Galois Field Arithmetic Library in C/C++:

| | |
|---|---|
| ** | http://www.cs.utk.edu/~plank/plank/papers/CS-07-593/ |

**
*/
/* the prime polynomial is x\hat{ }16+x\hat{ }12+x\hat{ }3+x+1 (Blahut p. 82) */
/* 0210013 */
/* 1 0001 0000 0000 1011 */
/* 1 1 0 0 B*/

| | |
|---|---|
| #define POLYNOMIAL | 0x1100B |

| | |
|---|---|
| #define OVERFLOW | 0x10000 |

| | |
|---|---|
| static unsigned short logtable[FMODULUS]; | /* logs logtable[base\hat{ }i]=i */ |

| | |
|---|---|
| static ffelement exptable[FMODULUS*2]; | /* exponents exptable[i]=base\hat{ }(i%(FMODULUS- |

1)) */
/*
** addition in the field is binary xor
*/
static ffelement _ffadd(ffelement x, ffelement y) { return x \hat{ } y; }
/*
** subtraction in the field is binary xor
*/
static ffelement _ffsub(ffelement x, ffelement y) { return x \hat{ } y; }
/*
** This is just a digit by digit multiplication
** which handles overflow by adding in a magic polynomial
** this is a modified version of the peasant's algorithm
*/
static ffelement _ffmul_long(ffelement x, ffelement y) {

ffelement sum;
ffaccum ay = y;
/* skip y = 0 */
if (y == 0)

return 0;

/* scan over the non-zero digits of x from right to left */
for (sum = 0; x != 0; x >>= 1) {

/* if x has a 1 in its low order digit, then add y to the result */
if (x & 1) sum \hat{ }= ay;
/* multiply y by two */
ay <<= 1;
/* if y has overflowed the field, then add in the magic polynomial */
if (ay & OVERFLOW) ay \hat{ }= POLYNOMIAL;

}
return sum;

}
/*
** This initialization knows that 2 is a base for our galois field
*/
static void _ffinit(void) {

ffelement base, base_to_power;
int power;
base = 2;
base_to_power = 1;
for (power = 0; power < FMODULUS*2; power += 1) {

exptable[power] = base_to_power;
base_to_power = _ffmul_long(base_to_power,base);

}
for (power = 0; power < FMODULUS; power += 1) {

logtable[exptable[power]] = power;

}

}
static ffelement _ffmul(ffelement x, ffelement y) {

return (x == 0 ∥ y == 0) ? 0 : exptable[logtable[x]+logtable[y]];

}
static ffelement _ffdiv(ffelement x, ffelement y) {

return (x == 0 ∥ y == 0) ? 0 : exptable[logtable[x]-logtable[y]+FMODULUS-1];

}
/*
** The external entries, for testing.
** The internal, static entries will be inlined.
*/
void ffinit(void) { _ffinit( ); }
ffelement ffadd(ffelement x, ffelement y) { return _ffadd(x,y); }
ffelement ffsub(ffelement x, ffelement y) { return _ffsub(x,y); }
ffelement ffmul(ffelement x, ffelement y) { return _ffmul(x,y); }
ffelement ffdiv(ffelement x, ffelement y) { return _ffdiv(x,y); }
unsigned short fflog(ffelement x) { return logtable[x]; }
ffelement ffexp(unsigned short x) { return exptable[x]; }
/*
** erasure coding
*/
#ifdef SWAP_BYTES
#define canshort(x) (x) = ((((x)>>8)&0x377)|((x)<<8))
#else
#define canshort(x) /* no swap required */
#endif
static ffelement **getmatrix(int rows, int cols);
static ffelement **getinverse(int n_missing_row, int *missing_row, int *present_col);
int ecencode(int nslice, int ncheck, int length, unsigned char *data, unsigned char *sums) {

/* fprintf(stderr, “ecencode(nslice=%d, ncheck=%d, length=%d, data=..., sums=...)\n”, nslice,

ncheck, length); */

if (nslice > MAX_ROWS)

return ecodec_fail(“encode: too many rows, increase MAX_ROWS and recompile”);

else if (ncheck > MAX_COLS)

return ecodec_fail(“encode: too many columns, increase MAX_COLS and recompile”);

else if ((length % (nslice*sizeof(ffelement))) != 0)

return ecodec_fail(“encode: data length not a multiple of nslice*sizeof(ffelement)”);

else {

ffelement **matrix = getmatrix(nslice, ncheck);
ffelement *ffdata = (ffelement *)data;
ffelement *ffsums = (ffelement *)sums;
int i, j, k, kn = length / (nslice * sizeof(ffelement));
ffelement sum;
/* oh, no, this is a canonical byte ordering situation

some machines will need to swap bytes */

/* oh, yes, we can put all the byte swapping into our arithmetic -- TODO, byte swapped ff

arithmetic */

for (k = 0; k < kn; k += 1) {

for (j = 0; j < ncheck; j += 1) {

sum = 0;
for (i = 0; i < nslice; i += 1) {

ffelement elt = ffdata[i*kn+k];
canshort(elt);
sum = _ffadd(sum, _ffmul(elt, matrix[i][j]));

}
canshort(sum);
ffsums[j*kn+k] = sum;

}

}
return 0;

}

}
int ecdecode(int nslice, int ncheck, int *index, int length, unsigned char *data, unsigned char
*result) {

/* fprintf(stderr, “ecdecode(nslice=%d, ncheck=%d, index, length=%d, data)\n”, nslice, ncheck,

length); */

if (nslice > MAX_ROWS)

return ecodec_fail(“decode: too many rows, increase MAX_ROWS and recompile”);

else if (ncheck > MAX_COLS)

return ecodec_fail(“decode: too many columns, increase MAX_COLS and recompile”);

else if ((length % (nslice*sizeof(ffelement))) != 0)

return ecodec_fail(“decode: data length not a multiple of nslice*sizeof(ffelement)”);

else {

ffelement *ffdata = (ffelement *)data, *ffresult = (ffelement *)result;
ffelement *ffdata_rows[MAX_ROWS+MAX_COLS], *ffresult_rows[MAX_ROWS];
int missing_rows[MAX_COLS], present_cols[MAX_COLS];
int i, j, k, kn = (length / nslice) / sizeof(ffelement), n_missing_row = 0, n_present_col = 0;
/* mark all the data rows, slices and checksums, as missing */
for (i = 0; i < nslice+ncheck; i += 1) {

ffdata_rows[i] = NULL;

}
/* find the data rows, slices and checksums, which are present */
for (i = 0; i < nslice; i += 1) {

if (index[i] >= nslice+ncheck) {

return ecodec_fail(“decode: index of data row is greater than or equal to nslice+ncheck”);

}
if (ffdata_rows[index[i]] != NULL) {

/* fprintf(stderr, “index %d is duplicated\n”, index[i]); */
return ecodec_fail(“decode: duplicate index”);

}
ffdata_rows[index[i]] = ffdata + i*kn;
/* fprintf(stderr, “pointing ffdata row[%d] to ffdata at %d * %d = %.*s\n”,

index[i], i, kn, kn*sizeof(ffelement), ffdata_rows[index[i]]); */

/* make the result row pointers */
ffresult_rows[i] = ffresult + i*kn;

}
/* scan to find which slices are missing and which checksums are preset */
for (i = 0; i < nslice+ncheck; i += 1) {

if (ffdata_rows[i] == NULL) {

/* this slice or checksum is missing */
if (i < nslice) {

/* this slice is missing */
if (n_missing_row >= MAX_COLS) {

return ecodec fail(“decode: too many missing rows”);

}
missing_rows[n_missing_row++] = i;
/* fprintf(stderr, “missing row %d\n”, i); */

}

} else {

/* this slice or checksum is not missing */
if (i >= nslice) {

/* this checksum is not missing */
if (n_present_col >= MAX_COLS) {

return ecodec_fail(“decode: too many present cols”);

}
present_cols[n_present_col++] = i-nslice;
/* fprintf(stderr, “present col %d\n”, i-nslice); */

}

}

}
/* check that we have the right numbers of parts */
if (n_missing_row != n_present_col) {

/* fprintf(stderr, “ecdecode(nslice=%d,ncheck=%d,...,length=%d,...), n_missing_row=%d,

n_present_col=%-d\n”,

nslice, ncheck, length, n_missing_row, n_present_col); */

return ecodec_fail(“decode: number of missing rows does not equal number of supplied

columns”);

}
/* if there are missing rows we need to fill them in */
if (n_missing_row != 0) {

ffelement res, **inverse, **matrix, gvec[MAX_COLS];
int nres;
/* get the cauchy matrix */
matrix = getmatrix(nslice, ncheck);
/* get the cauchy inverse */
inverse = getinverse(n_missing_row, missing_rows, present_cols);
/* now scan the received data to construct the missing rows */
/* do this one column of slice depth at a time */
for (k = 0; k < kn; k += 1) {

for (j = 0; j < n_missing_row; j += 1) {

res = ffdata_rows[present_cols[j]+nslice][k]; /* ??? need the kth element of the known

checksum */

canshort(res);
gvec[j] = res;

}
for (i = 0; i < nslice; i += 1) {

if (ffdata_rows[i] != NULL) {

for (j = 0; j < n_missing_row; j += 1) {

res = ffdata_rows[i][k];
canshort(res);
gvec[j] = _ffsub(gvec[j], _ffmul(matrix[i][present_cols[j]], res));

}

}

}
nres = 0;
for (i = 0; i < nslice; i += 1) {

if (ffdata_rows[i] == NULL) {

res = 0;
for (j = 0; j < n_missing_row; j += 1) {

res = _ffadd(res, _ffmul(inverse[j][nres], gvec[j]));

}
/* res = ‘.’+(‘.’<<8); *//* temporary */
ffresult_rows[i][k] = res;
nres += 1;

} else {

res = ffdata_rows[i][k];
canshort(res);
ffresult_rows[i][k] = res;

}

}

}

} else {

/* no missing rows, simply copy the received slices into the correct order */
ffelement res;
for (k = 0; k < kn; k += 1) {

for (i = 0; i < nslice; i += 1) {

res = ffdata_rows[i][k];
canshort(res);
ffresult_rows[i][k] = res;

}

}

}
return 0;

}

}
static ffelement matrix_xvec[MAX_ROWS];
static ffelement matrix_yvec[MAX_COLS];
static ffelement **getmatrix(int nrows, int ncols) {

static int matrix_nrows;
static int matrix_ncols;
static ffelement matrix[MAX_ROWS][MAX_COLS];
static ffelement *matrix_rows[MAX_ROWS];
if (matrix_rows[0] != &matrix[0][0]) {

/* compute row pointers for cauchy matrix */
int i;
for (i = 0; i < MAX_ROWS; i += 1)

matrix_rows[i] = &matrix[i][0];

}
if (matrix_nrows != nrows ∥ matrix_ncols != ncols) {

/* construct a new cauchy matrix */
int i, j;
/* set new cauchy matrix dimensions */
matrix_nrows = nrows;
matrix_ncols = ncols;
/* compute cauchy x vector */
for (i = 0; i < nrows; i += 1) {

matrix xvec[i] = i+1;

}
/* compute cauchy y vector */
for (j = 0; j < ncols; j += 1) {

matrix_yvec[j] = nrows+j+1;

}
/* compute cauchy matrix */
for (i = 0; i < nrows; i += 1) {

for (j = 0; j < ncols; j += 1) {

matrix[i][j] = _ffdiv(1, _ffadd(matrix_xvec[i], matrix_yvec[j]));

}

}

}
return matrix_rows;

}
static ffelement **getinverse(int n_missing_row, int *missing_rows, int *present_cols) {

static ffelement inverse[MAX_COLS][MAX_COLS];
static ffelement *inverse_rows[MAX_COLS];
int i, j, k;
ffelement xvec[MAX_COLS], yvec[MAX_COLS];
ffelement n1[MAX_COLS], n2[MAX_COLS], d1[MAX_COLS], d2[MAX_COLS];
if (inverse_rows[0] != &inverse[0][0]) {

/* compute row pointers for inverse matrix */
for (i = 0; i < MAX_ROWS; i += 1)

inverse_rows[i] = &inverse[i][0];

}
/* construct the reduced xvec and yvec */
for (i = 0; i < n_missing_row; i += 1) {

xvec[i] = matrix_xvec[missing_rows[i]];
yvec[i] = matrix_yvec[present_cols[i]];

}
/* intermediate results */
for (i = 0; i < n_missing_row; i += 1) {

n1[i] = n2[i] = d1[i] = d2[i] = 1;
for (k = 0; k < n_missing_row; k += 1) {

n1[i]= _ffmul(n1[i], _ffadd(xvec[k], yvec[i]));
n2[i]= _ffmul(n2[i], _ffadd(xvec[i], yvec[k]));
if (i!= k) {

d1[i] = _ffmul(d1[i], _ffsub(xvec[i], xvec[k]));
d2[i] = _ffmul(d2[i], _ffsub(yvec[k], yvec[i]));

}

}

}
/* computation of inverse */
for (i = 0; i < n_missing_row; i += 1) {

for (j = 0; j < n_missing_row; j += 1) {

inverse[i][j] = _ffdiv(_ffdiv(_ffmul(_ffmul(_ffdiv(1, _ffadd(xvec[j],yvec[i])), n1[i]), n2[j]), d1[j]),

d2[i]);

}

}
return inverse_rows;

}

The present invention has the advantages of the Zebra file system and the fault tolerance of BitTorrent, with only a relatively small cost for replication. Since a very small amount of additional data is needed to assure fault tolerance, it has an immense advantage over the prior art. The invention provides space efficiency, storing data that is robust against errors much more efficiently than mirroring strategies that simply make multiple copies, thereby providing robust storage with the benefits of distributed striping. In addition, it is easy to add resources as needed. The present invention therefore gives the user the ability to determine how much redundancy he wants and to provision the system accordingly. In addition, repair is simple, being effected by simply replacing defective disk drives and then reconstructing automatically the missing data. A storage system can therefore be constructed which can be upgraded effortlessly to produce a storage system that will last forever as it is incrementally upgraded and replaced.

The benefits of the erasure codes of the present invention include, but are not limited to, better space efficiency than mirroring/replication strategies, the ability to choose the degree of redundancy in the code (or even dynamically for each file), which combined with the expected failure rate of slice storage gives the expected time to failure or how long until the data needs to be refreshed if it is desirable to keep it longer, the ability to make the code hierarchical, which allows for more probable errors to be corrected at less expense than the less probable, triple witching hour errors, and the ability to tune the number of slices required for reconstruction to be the number, which the expected network transport can deliver most effectively. The present invention makes it possible to build a variety of storage systems that vary these parameters to meet different requirements, with all of the storage systems being based on a very simple underlying slice storage server.

A specific benefit of the present invention is that it provides hyper-resilient data. The system can protect against a large number of disk failures (or node failures). Parameters can be configured to select the level of data resiliency that is desired. Specifically, up to k failures can be protected against, where k is the number of checksums it has been chosen to calculate. For example, protection against the failure of two nodes in a network is achieved by calculating 2 checksums. In practice, a safety factor might be added, in order to protect against more node failures than are normally expected to occur (e.g., a safety factor of 3 checksums might be added in this example, so that the data could be reconstructed despite 5 node failures).

The present invention also has a lower redundancy cost. Using this system, the number of servers needed to store a given amount of data in a resilient manner can be dramatically reduced. This is achieved by lowering the amount of extra space needed to achieve data redundancy. In this system, the redundancy cost is k/n. The parameters can be configured to achieve a particular cost. For example, if a 1% redundancy cost is desired, set n equal to 500 and k equal to 5 (by dividing an original data block into 500 data slices and calculating 5 checksums). This yields a redundancy cost of 5/500, or 1%. A comparison illustrates how the present invention can store data in a more resilient manner using less space. In the example, the data can be recovered despite the loss of 5 nodes, the stored data occupies 101% of the space of the original, and the redundancy cost is 1%. By comparison, with a traditional, single backup, the data is protected against the loss of only one copy, the original and replica occupy 200% of the original space, and the redundancy cost is 100%. Parameters can be configured to achieve different levels of data resiliency and redundancy cost, with the example above presenting just one of many possibilities.

Redundancy cost may be reduced even further by taking advantage of to a feature of cryptographic hashes: Suppose many copies of the same file (e.g., a You Tube video) would reside in many places in a traditional network. In the present system, the hash of each of the identical files would be the same, and thus the hash would be stored only once. In any event, a much lower redundancy cost can be achieved than when either traditional backup (i.e., replication) or RAID are employed.

In some implementations, speed can be increased by concurrently reading and writing small shreds from multiple remote points. This can be faster than reading and writing a large original file from a local disk. The system is also scalable, in that it enables a large storage system to be built out of identical, simple units. These units could consist of commodity, off-the-shelf disks with a simple operating system, such as a stripped-down version of Linux. Also, the system is scalable in the sense that the number of nodes in the storage ring can be easily increased or decreased. Consistent hashing is used to map keys to nodes. A benefit of doing so is that, when a node is removed or added, the only keys that change are those associated with adjacent nodes. The storage system could therefore serve as a foundation for computing at the exascale.

One of the major advantages of the present invention is that it can be used to produce a general purpose, fault tolerant, scalable, data storage system. This system is much more efficient than present methods, for example the Google File System which essentially uses mirroring techniques to insure data reliability. In addition when used in conjunction with methods such as map reduce it produces a more efficient parallel system than for example Google uses since one can insure that all data is available and the problem of stragglers [Jeffery Dean, Sanjay Ghemawat, Distributer Programming with MapReduce, Beautiful Code, Oram & Wilson, O'Reilly, 2007; Sanjay Ghemawat, Howard Gobioff, Shun-Tak Leung, 19th ACM Symposium on Operating Systems Principles, Lake George, N.Y., October, 2003] is eliminated.

While the invention has been described with respect to its application to the problems of restoration, receipt, or distribution of data or processes under possible failure, it will be clear to one of skill in the art that it has many other suitable applications, including, but not limited to, video distribution, automatic updates, distributed file systems, and data storage applications. The erasure codes of the present invention may also be used in any application where older and/or less efficient erasure codes are presently used.

One useful application is a distributed file system. Historically, machines have been constructed like islands and all major subsystems are replicated in each machine. This model makes substantially less sense today, when machines are reliably networked. One can imagine a time when every personal computer (even portables) have a high speed network persistent connection. In this environment it makes no sense to have all the resources needed for each machine duplicated everywhere. Using the present invention, a file system can be constructed that is distributed among a large number of machines. This has a number of advantages including, but not limited to, that data will never have to be backed up since the system will have its own redundancy, that it will run faster, and that it will take less storage space because, using distributed hash tables, it is only necessary to store one copy of every file. The distributed hash table may be implemented by taking a cryptographic hash of each file, using that as the address or i-node of the file, and only storing the data once for each hash. By using compression on files, the amount of space will be reduced, which is in addition to the fact that a significant amount of space will be saved by only storing one instance of each file. Files can also be encrypted, so that the fact that files are distributed will not affect security.

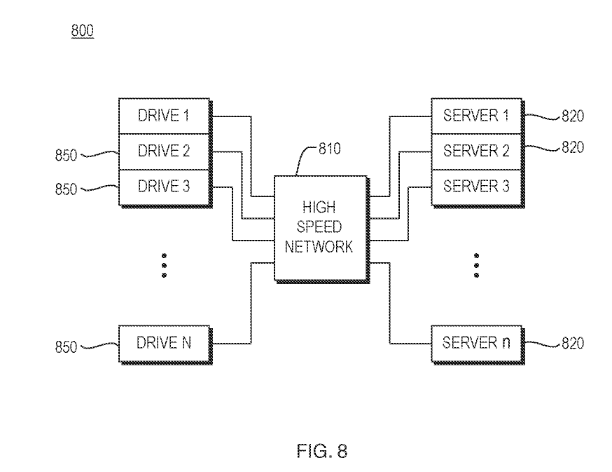

FIG. 8 is a block diagram illustrating an exemplary embodiment of a distributed file system employing web servers, according to one aspect of the present invention. Storage can conveniently be added as necessary, with data being sliced and stored according to the methods of the present invention. In FIG. 8, distributed file system 800 comprises high speed network 810 linking n web servers 820 and n drives 850.

Another useful application of the present invention is distributed computation. The high-level implementation language and other features of the present invention are well suited for concurrent processing. For example, nodes are enabled, acting independently, to gather the data they need to run concurrent processes. Languages such as Erlang that permit distribution of computation in a fault tolerant way may be used in conjunction with the distributed storage methods of the present invention in order to provide distributed computation having the additional advantage of fault-tolerant distributed storage where resources can be added as needed. When such a system uses disk instead of the memory required by Scalaris, and uses erasure codes for storage, an improved distributed computation model is obtained which is fault tolerant and redundant.

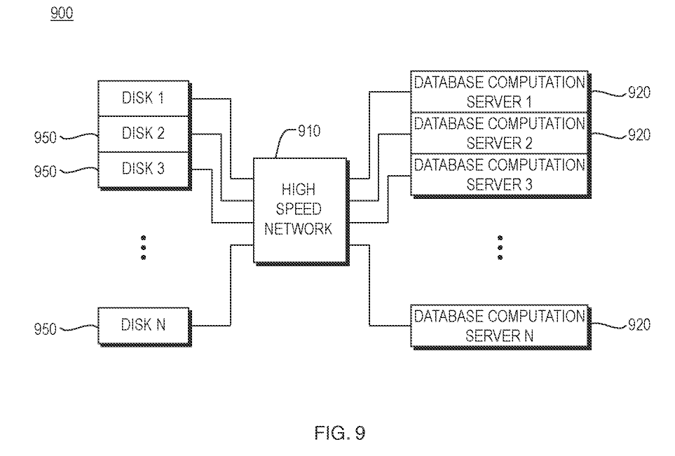

FIG. 9 is a block diagram illustrating an embodiment of a system for distributed database computation, according to one aspect of the present invention. In this embodiment, data and computation tasks are distributed among multiple disks and computation servers using the methods of the present invention. The system may be easily expanded as the load requires. In FIG. 9, distributed database computation system 900 comprises high speed network 910 linking n database computation servers 920 and n storage disks 950.

The present invention may also be advantageously employed to provide distributed data storage system and method, in which data is stored on a network. When stored, a file does not exist on any one drive. Rather, the file is shredded and the shreds are stored on many drives. This makes the data hyper-resilient, in a manner analogous to the robustness of packet switching. With packet switching, data packets can be routed to their destination despite the failure of nodes in the transmission system. Using the present invention, all data in a storage ring can be recovered, despite the failure of nodes in the ring. The basic method of the system is: (1) Divide an original data block into n data slices, (2) Use Cauchy-Reed-Solomon erasure codes to compute k checksums, (3) Calculate a cryptographic hash for each data slice and checksum, and (4) Store the n+k slices (consisting of n data slices and k checksums) on a distributed storage ring. Each node is responsible for a sector of the cryptographic hash range, and each shred is stored at the node responsible for the hash of the shred's address. No more than one slice is stored at any node. Thus, n+k slices (consisting of n data slices and k checksums) are stored on n+k nodes of a storage ring. The checksums are designed so that, in order to reconstruct the original data block, it is not required to retrieve all of the slices. Rather, it is sufficient if a total of least n data slices or checksums are retrieved. The other k data slices or checksums are not needed. Thus, the original data can be reconstructed despite the failure of up to k nodes. Put differently, in order to protect against the failure of k nodes, k checksums are calculated.

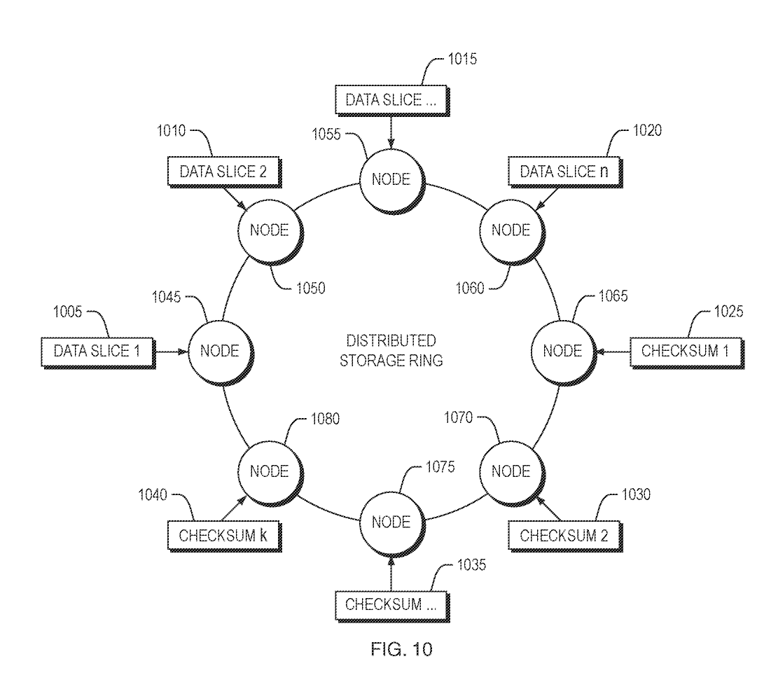

FIG. 10 is a diagram that illustrates an exemplary implementation of distributed data storage according to one aspect of the present invention. In FIG. 10, n+k slices 1005, 1010, 1015, 1020, 1025, 1030, 1035, 1040, consisting of n data slices 1005, 1010, 1015, 1020 and k checksums 1025, 1030, 1035, 1040, are stored on n+k nodes 1045, 1050, 1055, 1060, 1065, 1070, 1075, 1080 of distributed storage ring 1090. The original data can be reconstructed despite the failure of up to k nodes. By using k checksums, data is protected against the loss of k nodes. In one embodiment, extra checksums are calculated to provide an enhanced safety factor.

Structured Overlay Network. The nodes participating in the storage system are organized into a structured overlay network that provides routing services and implements a distributed hash table. The structured overlay operates much like the Chord/Dhash system from MIT and other peer-to-peer networking systems proposed in the last decade, but adapted to sets of peers more focused than ad hoc file sharers.

Decentralized Storage with Independent, Concurrently Acting Nodes. In this approach, storage is decentralized. A stored file does not reside at any particular node. Rather, the file shreds or slices are distributed for storage throughout the system. Any node, acting independently, may initiate queries to the other nodes to retrieve these slices or shreds. As soon as the node that initiated the query receives back at least n slices, it can reconstruct the file. It does not need to wait to hear back from the remaining nodes. Each participant can gather the data it needs to support the concurrent processes it is executing. In contrast, in a conventional distributed system, responsibility for a file is centralized to some extent. One or more nodes have responsibility for a particular file, and can act as a bottleneck. The system is truly distributed in that none of the participants is any more important or indispensable than any other. Each participant, acting independently, can gather the data it needs to support the concurrent processes it is executing. This degree of distribution is important. It is a radical departure from a conventional approach that tries to make a remote file behave like one on a local system.

Another useful application of the present invention is adaptive distributed memory. The flexibility of the erasure coding of the present invention permits another way to envision cloud storage. A user who writes an item of data can choose the erasure coding parameters to ensure that the item may be recovered after some number of slice failures, that the reconstruction of the item will require a certain amount of work after some number of slice failures, and that the item should be checked after a certain period of time to ensure that the erasure coding is operating to specification. These parameters may be chosen according to some anticipated rate of disk failure, of slice server disconnection, of data access, and/or of access urgency, or the parameters may be adaptively learned by watching how erasure-coded data works over time. The user of a data storage system would specify the expected usage of their stored data, sample the properties of the storage system, and choose the erasure coding parameters accordingly. They would also sample the properties of the storage system at later times and update the encoding of their data if necessary to meet the expected usage of their stored data. This may also be extended to include sampling the actual usage of their stored data, in order to see that it meets the expected usage.

It will be clear to one of skill in the art that the present invention has many other potential applications. These include, but are not limited to, a flexible combat ring, server farms, self-restoring hard drives, scratch-resistant CDs and DVDs, flash memory, and highly efficient forward error correction in data transmission. For example, in a flexible storage ring for use in combat, nodes (consisting, for example, of wirelessly enabled computers carried by tactical units) could join or leave the ring, and all data could be recovered despite the loss of numerous nodes. Large server farms are appropriate in some cases for intelligence gathering, cloud computing and parallel, distributed computation, and the present invention could be used to achieve reductions in the number of servers needed on such farms because is resilient in the case of failure and can be scaled by simply adding more hardware.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A distributed data storage system, comprising:
data storage processor, the data storage processor being specifically adapted for breaking data into n slices and k checksums using at least one matrix-based erasure code, and for storing the slices and checksums on a plurality of storage elements, wherein the matrix-based erasure code is based on a type of matrix selected from the class of matrices whose submatrices are invertible; and
data restoration processor, the data restoration processor being specifically adapted for retrieving the n slices from the storage elements and, when slices have been lost or corrupted, for retrieving the checksums from the storage elements and restoring the data using the at least one matrix-based erasure code and the checksums.

2. The system of claim 1, wherein at least some of the storage elements are disk drives or flash memories.

3. The system of claim 1, wherein the storage elements comprise a distributed hash table.

4. The system of claim 1, wherein the matrix-based erasure code uses Cauchy or Vandermonde matrices.

5. The system of claim 1, wherein the system is geographically distributed.

6. A distributed file system, comprising:
file system processor, the file system processor being specifically adapted for breaking a file into n file pieces and calculating k checksums using at least one matrix-based erasure code, and for storing or transmitting the slices and checksums across a plurality of network devices, wherein the matrix-based erasure code is based on a type of matrix selected from the class of matrices whose submatrices are invertible; and
file restoration processor, the file restoration processor being specifically adapted for retrieving the n file pieces from the network devices and, when file pieces have been lost or corrupted, for retrieving the checksums from the network devices and restoring the file using the at least one matrix-based erasure code and the checksums.

7. The system of claim 6, wherein the matrix-based erasure code uses Cauchy or Vandermonde matrices.

8. A method for ensuring restoration and integrity of data in computer-related applications, comprising the steps of:
breaking the data into n pieces;
calculating k checksums related to the n pieces using at least one matrix-based erasure code, wherein the matrix-based erasure code is based on a type of matrix selected from the class of matrices whose submatrices are invertible;
storing the n pieces and k checksums on n+k storage elements or transmitting the n pieces and k checksums over a network;
retrieving the n pieces from the storage elements or network; and
if pieces have been lost or corrupted,
retrieving the checksums from the storage elements or network; and
restoring the data using the at least one matrix-based erasure code and the checksums.

9. The method of claim 8, wherein the matrix-based erasure code uses Cauchy or Vandermonde matrices.
